(19) United States
(12) Patent Application Publication
(10) Pub. No.: US 2019/0179184 A1
(43) Pub. Date: Jun. 13, 2019

(54) LIQUID CRYSTAL DISPLAY DEVICE AND METHOD FOR PRODUCING THE SAME

(71) Applicant: Sharp Kabushiki Kaisha, Sakai City, Osaka (JP)

(72) Inventors: TSUYOSHI OKAZAKI, Sakai City (JP); MASANOBU MIZUSAKI, Sakai City (JP); YUKO TERAOKA, Sakai City (JP)

(21) Appl. No.: 16/324,106

(22) PCT Filed: Aug. 3, 2017
(86) PCT No.: PCT/JP2017/028158

§ 371 Date: Feb. 7, 2019

(30) Foreign Application Priority Data
Aug. 10, 2016 (JP) 2016-158066

(51) Int. Cl. G02F 1/1339; C09K 19/30; G02F 1/1337; C09K 19/12

(52) U.S. Cl. CPC G02F 1/1339; C09K 19/30; C09K 2019/525; C09K 19/12; G02F 1/1337

(57) ABSTRACT

The present invention provides a liquid crystal display device and a method of producing the same in which the occurrence of a bright dot at an edge portion of a display region is suppressed during use in a wide temperature range. The liquid crystal display device of the present invention includes: a liquid crystal layer disposed between a first substrate and a second substrate; an alignment film disposed adjacent to the liquid crystal layer of at least one of the first substrate or the second substrate; and a sealing material to achieve adhesion between the first substrate and the second substrate, wherein the liquid crystal layer contains a liquid crystal material, the liquid crystal material contains an alkoxy group-containing liquid crystal compound and exhibits a liquid crystal phase at −10° C. or higher and 80° C. or lower, the sealing material is a cured product of an epoxy resin-containing sealant, and the alignment film includes at least one of a first alignment film including a polymer layer formed using a first alignment agent containing a polyamic acid and a polysiloxane, or a second alignment film including a polymer layer formed using a second alignment agent containing a polyamic acid in which a silane coupling agent is adsorbed onto a surface of the polymer layer.

### TECHNICAL FIELD

The present invention relates to liquid crystal display devices and methods for producing the same. More specifically, the present invention relates to a liquid crystal display device suitable for use in a wide temperature range, and a method of producing the liquid crystal display device.

### BACKGROUND ART

Liquid crystal display devices are display devices that use a liquid crystal composition for display. According to a typical display method, light is emitted from a backlight unit to a liquid crystal display panel including a liquid crystal composition enclosed between a pair of substrates, and a voltage is applied to the liquid crystal composition to change the alignment of liquid crystal molecules, whereby the amount of light transmitted through the liquid crystal display panel is controlled. Such liquid crystal display devices have advantageous features such as thin profile, lightweight, and low power consumption, and are thus used in electronic devices such as televisions, smartphones, tablet personal computers, and automotive navigation systems.

In liquid crystal display devices, the alignment of liquid crystal molecules in a non-voltage applied state is generally controlled with an alignment film that has been subjected to alignment treatment. For example, Patent Literature 1 discloses a liquid crystal alignment film as a coating film onto which a silane-based surfactant containing linear carbon chains and Si is chemically adsorbed via energy beam-sensitive resin and in which the linear carbons are aligned in a specific direction.

### CITATION LIST

### Patent Literature

Patent Literature 1: JP H10-153783 A

### SUMMARY OF INVENTION

### Technical Problem

Liquid crystal display devices, such as digital signage liquid crystal display devices and in-vehicle liquid crystal display devices which are used in environment with large temperature changes, include a liquid crystal material that exhibits a liquid crystal phase at −30° C. to 90° C., for example, and the liquid crystal material may contain an alkoxy group-containing liquid crystal compound. A polyamic acid is highly adhesive to a resin contained in a sealing material and is hardly soluble in the liquid crystal material, so that it is suitably used as a material of alignment films for liquid crystal display devices.

The present inventors studied liquid crystal display devices in which the alkoxy group-containing liquid crystal compound is used. They found that when the alkoxy group-containing liquid crystal compound is used in combination with a sealing material containing an epoxy resin and an alignment film formed using a polyamic acid, a bright dot occurs at an edge portion of the display region during use of the liquid crystal display devices in a wide temperature range. Patent Literature 1 is silent about a technique that suppresses the occurrence of such a bright dot. Thus, the present inventors more specifically studied the occurrence of a bright dot.

FIG. 7 is a schematic view showing conversion of an epoxy group of an epoxy resin into a diol. FIG. 8 is a schematic view showing hydrogen bonding between an epoxy resin containing a diol and a liquid crystal compound containing an alkoxy group. As shown in FIG. 7, an epoxy resin 51 contained in the sealing material absorbs moisture from outside a panel (cell) and is converted into an epoxy-derived-diol 52. As the imidization ratio of polyamic acid contained in an alignment film is lower, i.e., the carboxyl group content is higher, the diol formation is facilitated by an acid derived from the carboxyl group, as shown in FIG. 7.

The epoxy-derived-diol 52 formed in the sealing material, particularly near the interface between the sealing material and the alignment film, has a tendency to form a hydrogen bond 32 with an —O— group of an alkoxy group-containing liquid crystal compound 31 contained in a liquid crystal layer, as shown in FIG. 8. Thus, as the liquid crystal display device is repeatedly exposed to low and high temperatures, the epoxy-derived-diol 52 is incorporated into the liquid crystal layer over time. Specifically, when the liquid crystal display device is left in a high-temperature environment, the epoxy-derived-diol 52 formed in the sealing material dissolves into the liquid crystal layer due to thermal fluctuations. Subsequently, when the liquid crystal display device is left in a low-temperature environment, a hydroxyl group of the epoxy-derived-diol 52 forms the hydrogen bond 32 with an alkoxy group of the alkoxy group-containing liquid crystal compound 31.

In the case where a liquid crystal material that changes from the liquid crystal phase to a solid at a low temperature is used, since the solid has no fluidity, no hydrogen bond 32 is formed between the epoxy-derived-diol 52 and the alkoxy group-containing liquid crystal compound 31. However, in the case where a liquid crystal material capable of maintaining the liquid crystal phase even at a low temperature such as −30° C. to −10° C. is used, the hydrogen bond 32 is easily formed between the epoxy-derived-diol 52 and the alkoxy group-containing liquid crystal compound 31.

Here, the epoxy resin contains in one molecule at least two hydroxyl groups that are formed by a reaction with moisture, so that two hydrogen bonds 32 are formed in one molecule of the epoxy resin. Thus, once the hydrogen bonds 32 are formed and stabilized between the alkoxy group-containing liquid crystal compound 31 and the epoxy-derived-diol 52, these hydrogen bonds become insoluble and precipitate in the liquid crystal layer, disturbing the alignment in the liquid crystal layer and causing a display defect such as a small bright dot. The bright dot is more noticeable in liquid crystal display devices for outdoor use and in-vehicle use, for example, which are used in a wide temperature range. The bright dot easily occurs particularly in in-vehicle liquid crystal display devices for use in a temperature range of −30° C. to 90° C.

Presumably, this is because the epoxy resin easily reacts with water and the epoxy-derived-diol 52 easily dissolves into the liquid crystal layer 30 at higher temperatures, and the hydrogen bonds 32 are easily formed between the epoxy-derived-diol 52 and the alkoxy group-containing liquid crystal compound 31 at lower temperatures.

Thus, in order to suppress the occurrence of the bright dot, it is important that an acid derived from the carboxyl group of the polyamic acid is prevented from coming into contact with the epoxy resin contained in the sealing material and being incorporated thereinto. Generally, a polyamic acid is considered to be partially dehydrated and cyclized through a baking (pre-baking and post-baking) step of the alignment film, reducing the number of carboxyl groups. For example, even in the case of a polyamic acid having an imidization ratio of 0%, ultimately, the imidization ratio may increase up to about 50% through the baking (pre-baking and post-baking) step of the alignment film. However, the bright dot still occurs even in such a case.

The present invention has been made in view of such a current state of the art and aims to provide a liquid crystal display device and a method of producing the same in which the occurrence of a bright dot at an edge portion of a display region is suppressed during use in a wide temperature range.

### Solution to Problem

The inventors of the present invention conducted various studies on liquid crystal display devices in which the occurrence of a bright dot at an edge portion of the display region is suppressed during use in a wide temperature range. The inventors found that the occurrence of a bright dot at an edge portion of the display region during use in a wide temperature range can be effectively suppressed by the use of at least one of an alignment film including a polymer layer formed using an alignment agent containing a polyamic acid and a polysiloxane, or an alignment film including a polymer layer formed using an alignment agent containing a polyamic acid in which a silane coupling agent is chemically adsorbed onto a surface of the polymer layer. In this manner, the number of carboxyl groups near the interface between the liquid crystal layer and the alignment film and near the interface between the alignment film and the sealing material was significantly reduced. Thus, the inventors arrived at the solution to the above problem, completing the present invention.

Specifically, one embodiment of the present invention may be a liquid crystal display device including: a first substrate; a second substrate disposed opposite to the first substrate; a liquid crystal layer disposed between the first substrate and the second substrate; an alignment film disposed on at least one of the first substrate or the second substrate, on the side facing the liquid crystal layer; and a sealing material to achieve adhesion between the first substrate and the second substrate, wherein the liquid crystal layer contains a liquid crystal material, the liquid crystal material contains an alkoxy group-containing liquid crystal compound and exhibits a liquid crystal phase at −10° C. or higher and 80° C. or lower, the sealing material is a cured product of an epoxy resin-containing sealant, and the alignment film includes at least one of a first alignment film including a polymer layer formed using a first alignment agent containing a polyamic acid and a polysiloxane, or a second alignment film including a polymer layer formed using a second alignment agent containing a polyamic acid in which a silane coupling agent is chemically adsorbed onto a surface of the polymer layer.

The liquid crystal compound may be a compound represented by the following chemical formula (L):

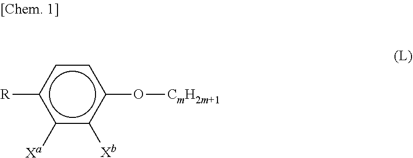

wherein X^{a} and X^{b} each independently represent a hydrogen atom, a fluorine atom, or a chlorine atom; R represents a monovalent organic group; and m represents an integer of 1 to 18, with the proviso that when one of X^{a} or X^{b} is a hydrogen atom, the other one represents a fluorine atom or a chlorine atom.

The liquid crystal compound may be a compound represented by any one of the following chemical formulae (L1) to (L5):

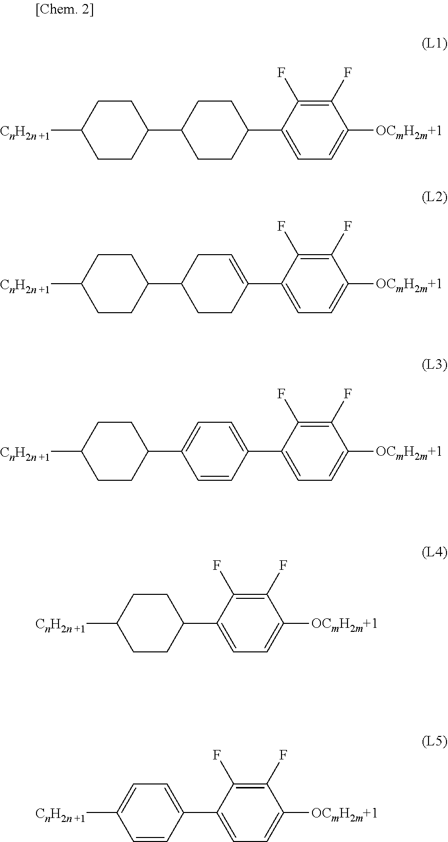

wherein m and n each independently represent an integer of 1 to 18.

The liquid crystal material may exhibit a liquid crystal phase at −30° C. or higher and 90° C. or lower.

The silane coupling agent may be a compound represented by the following chemical formula (SC1):

[Chem. 3]

(Z)₃Si—(CR¹₂)ₐ—CR²₃ (SC1)

wherein each Z independently represents a chlorine atom, a methoxy group, or an ethoxy group; each R¹ independently represents a hydrogen atom or a halogen atom; each R² independently represents a hydrogen atom or a halogen atom; and a represents an integer of 0 to 17.

The silane coupling agent may be a compound represented by the following chemical formula (SC2) or (SC3):

[Chem. 4]

(Z)₃Si—(CH₂)ₐ—CF₃ (SC2)

wherein each Z independently represents a chlorine atom, a methoxy group, or an ethoxy group; and a represents an integer of 0 to 17,

[Chem. 5]

(Z)₃Si—(CH₂)_{b}—C₂F₅ (SC3)

in chemical formula (SC3), each Z independently represents a chlorine atom, a methoxy group, or an ethoxy group; and b represents an integer of 0 to 16.

The polysiloxane may contain at least one functional group selected from the group consisting of an epoxy group and an isocyanate group.

The first alignment film and the second alignment film may each include multiple polymer layers each containing a different polymer.

The alignment film may include the first alignment film.

The first alignment film may contain a silane coupling agent chemically adsorbed onto the surface of the polymer layer formed using the first alignment agent.

The alignment film may include the second alignment film.

The second alignment agent may further contain a polysiloxane.

Another embodiment of the present invention may be a method of producing a liquid crystal display device, including: an alignment film forming step of forming an alignment film on at least one of a first substrate or a second substrate; a sealant applying step of applying an epoxy resin-containing sealant to the at least one substrate; a sealant curing step of bonding the first substrate and the second substrate together and curing the sealant; and a liquid crystal layer forming step of forming a liquid crystal layer between the first substrate and the second substrate using a liquid crystal material that contains an alkoxy group-containing liquid crystal compound and that exhibits a liquid crystal phase at −10° C. or higher and 80° C. or lower, wherein the method includes, as the alignment film forming step, at least one of a first step of forming a polymer layer on the at least one substrate using a first alignment agent containing a polyamic acid and a polysiloxane, or a second step of forming a polymer layer on the at least one substrate using a second alignment agent containing a polyamic acid and then chemically adsorbing a silane coupling agent onto a surface of the polymer layer.

The method of producing a liquid crystal display device may include, as the alignment film forming step, the first step but not the second step.

The method of producing a liquid crystal display device may further include, as the alignment film forming step, a step of chemically adsorbing a silane coupling agent onto the surface of the polymer layer formed using the first alignment agent, after the first step.

The method of producing a liquid crystal display device may include, as the alignment film forming step, the second step but not the first step.

The second alignment agent may further contain a polysiloxane.

The liquid crystal compound may be a compound represented by the following chemical formula (L):

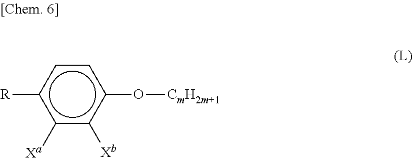

wherein X^{a} and X^{b} each independently represent a hydrogen atom, a fluorine atom, or a chlorine atom; R represents a monovalent organic group; and each m represents an integer of 1 to 18, with the proviso that when one of X^{a} or X^{b} is a hydrogen atom, the other one represents a fluorine atom or a chlorine atom.

The liquid crystal compound may be a compound represented by any one of the following chemical formulae (L1) to (L5):

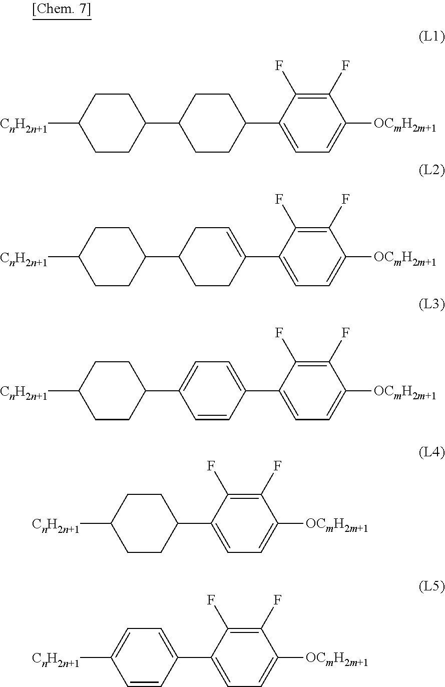

wherein m and n each independently represent an integer of 1 to 18.

The liquid crystal material may exhibit a liquid crystal phase at −30° C. or higher and 90° C. or lower.

The silane coupling agent may be a compound represented by the following chemical formula (SC1):

[Chem. 8]

(Z)₃Si—(CR¹₂)ₐ—CR²₃ (SC1)

wherein each Z independently represents a chlorine atom, a methoxy group, or an ethoxy group; each R¹ independently represents a hydrogen atom or a halogen atom; each R² independently represents a hydrogen atom or a halogen atom; and a represents an integer of 0 to 17.

The silane coupling agent may be a compound represented by the following chemical formula (SC2) or (SC3):

[Chem. 9]

(Z)₃Si—(CH₂)ₐ—CF₃ (SC2)

wherein each Z independently represents a chlorine atom, a methoxy group, or an ethoxy group; and a represents an integer of 0 to 17,

[Chem. 10]

(Z)₃Si—(CH₂)_{b}—C₂F₅ (SC3)

wherein each Z independently represents a chlorine atom, a methoxy group, or an ethoxy group; and b represents an integer of 0 to 16.

The polysiloxane may contain at least one functional group selected from the group consisting of an epoxy group and an isocyanate group.

The alignment film may include multiple polymer layers each containing a different polymer.

### Advantageous Effects of Invention

The present invention can provide a liquid crystal display device and a method of producing the same in which the occurrence of a bright dot at an edge portion of a display region is suppressed during use in a wide temperature range.

### BRIEF DESCRIPTION OF DRAWINGS

FIG. 1 shows a liquid crystal display device of Embodiment 1. FIG. 1(a) is a schematic cross-sectional view of the liquid crystal display device, and FIG. 1(b) is an enlarged schematic cross-sectional view near an alignment film of the liquid crystal display device.

FIG. 2 is a schematic cross-sectional view of a liquid crystal display device of Embodiment 2.

FIG. 3 is an enlarged schematic cross-sectional view of the liquid crystal display device of Embodiment 2.

FIG. 4 is a schematic cross-sectional view of a liquid crystal display device of Embodiment 3.

FIG. 5 is a schematic cross-sectional view of a substrate in the liquid crystal display device of each of Embodiments 2 and 3.

FIG. 6 is a schematic cross-sectional view of an intended substrate in a liquid crystal display device of Patent Literature 1.

FIG. 7 is a schematic view showing conversion of an epoxy resin into a diol.

FIG. 8 is a schematic view showing hydrogen bonding between an epoxy-derived-diol and an alkoxy group-containing liquid crystal compound.

### DESCRIPTION OF EMBODIMENTS

Hereinafter, the present invention is described in more detail based on embodiments with reference to the drawings. The embodiments, however, are not intended to limit the scope of the present invention. The configurations of the embodiments may appropriately be combined or modified within the spirit of the present invention.

### Embodiment 1

FIG. 1 shows a liquid crystal display device of Embodiment 1. FIG. 1(a) is a schematic cross-sectional view of the liquid crystal display device, and FIG. 1(b) is an enlarged schematic cross-sectional view near an alignment film of the liquid crystal display device. As shown in FIG. 1, a liquid crystal display device 1A of the present embodiment includes: a first substrate 10; a second substrate 20 disposed opposite to the first substrate 10; a liquid crystal layer 30 disposed between the first substrate 10 and the second substrate 20; an alignment film 40a disposed on each of the first substrate 10 and the second substrate 20, on the sides facing the liquid crystal layer 30; and a sealing material 50 to achieve adhesion between the first substrate 10 and the second substrate 20. The liquid crystal layer 30 contains a liquid crystal material, and the liquid crystal material contains an alkoxy group-containing liquid crystal compound and exhibits a liquid crystal phase at −10° C. or higher and 80° C. or lower. The sealing material 50 is a cured product of an epoxy resin-containing sealant. Each alignment film 40a is a polymer layer 41 formed using an alignment agent A containing a polyamic acid and a polysiloxane. The alignment film 40a corresponds to the first alignment film, and the alignment agent A corresponds to the first alignment agent.

The liquid crystal display device 1A of the present embodiment includes the liquid crystal layer 30 containing an alkoxy group-containing liquid crystal compound, the sealing material 50 which is a cured product of an epoxy resin-containing sealant, and the alignment films 40a formed using an alignment agent containing a polyamic acid. Thus, as described above, when the liquid crystal display device 1A is used in a wide temperature range, a bright dot may occur at an edge portion of a display region.

However, in the present embodiment, each alignment film 40a which is the polymer layer 41 formed using the alignment agent A containing a polyamic acid and a polysiloxane is used to distribute the polysiloxane near the interface of the alignment film 40a on the side facing the liquid crystal layer 30, significantly reducing the number of carboxyl groups near the interface between the liquid crystal layer 30 and the alignment film 40a and near the interface between the alignment film 40a and the sealing material 50. This can suppress the occurrence of a bright dot. Details of each configuration are described below.

### <Substrate>

The first substrate 10 and the second substrate 20 each include a transparent substrate, and at least one of the first substrate 10 or the second substrate 20 includes electrodes for applying a voltage to the liquid crystal layer 30. Examples of the transparent substrate include glass substrates and plastic substrates. The electrodes usually include pixel electrodes each disposed in the correspondinqg pixel and a common electrode shared by all the pixels.

### <Liquid Crystal Layer>

The liquid crystal layer 30 contains a liquid crystal material, and the liquid crystal material contains an alkoxy group-containing liquid crystal compound and exhibits a liquid crystal phase at −10° C. or higher and 80° C. or lower.

The liquid crystal material may have either positive or negative anisotropy of dielectric constant. However, since the alkoxy group-containing liquid crystal compound often has negative anisotropy of dielectric constant, the liquid crystal material preferably has negative anisotropy of dielectric constant. The anisotropy of dielectric constant (Δε) of the liquid crystal material is preferably −20 to −1.0, more preferably −12 to −1.5, still more preferably −10 to −2.0. The liquid crystal material having negative anisotropy of dielectric constant may be one referred to as a negative liquid crystal material.

The anisotropy of dielectric constant (Δε) is defined by the following formula (E1):

Δε=(Dielectric constant in major axis direction)−(Dielectric constant in minor axis direction) (E1)

The anisotropy of dielectric constant (Δε) of the liquid crystal material can be determined by producing a horizontal or vertical alignment liquid crystal cell and calculating the dielectric constant in the major axis direction and the dielectric constant in the minor axis direction using capacitance values before and after high voltage application.

The liquid crystal material exhibits a liquid crystal phase at −10° C. or higher and 80° C. or lower. The liquid crystal material exhibits a liquid crystal phase preferably at −30° C. or higher and 90° C. or lower, more preferably at −40° C. or higher and 100° C. or lower. This embodiment allows the liquid crystal display device to be suitably used for in-vehicle applications and digital signage applications which require the liquid crystal material to exhibit a liquid crystal phase in a wide temperature range.

The liquid crystal material contains an alkoxy group-containing liquid crystal compound, preferably a compound represented by the following chemical formula (L). When the liquid crystal material and the alkoxy group-containing liquid crystal compound have negative anisotropy of dielectric constant, X^{a} and X^{b} in the following chemical formula (L) are not hydrogen atoms. The amount of the alkoxy group-containing liquid crystal compound in the liquid crystal material is preferably 5% by weight to 50% by weight, more preferably 7% by weight to 40% by weight, still more preferably 10% by weight to 30% by weight, relative to the whole liquid crystal material. As described above, the liquid crystal material may contain one or more general liquid crystal compounds other than the alkoxy group-containing liquid crystal compound.

More preferably, the alkoxy group-containing liquid crystal compound includes a compound represented by any of the following chemical formulae (L1) to (L5). Still more preferably, the alkoxy group-containing liquid crystal compound includes a compound represented by the following chemical formula (L3) or (L4). It is particularly preferred that the liquid crystal material contains a compound represented by the following chemical formula (L3-1) as the compound represented by the following chemical formula (L3), and it is particularly preferred that the liquid crystal material contains a compound represented by the following chemical formula (L4-1) as the compound represented by the following chemical formula (L4). This embodiment can provide a liquid crystal material having good display characteristics even in an environment with larger temperature changes, i.e., it is possible to increase the temperature range of the liquid crystal phase.

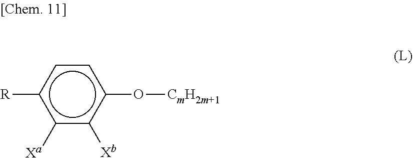

In the chemical formula (L), X^{a} and X^{b} each independently represent a hydrogen atom, a fluorine atom, or a chlorine atom; R represents a monovalent organic group; and m represents an integer of 1 to 18, with the proviso that when one of X^{a} or X^{b} is a hydrogen atom, the other one represents a fluorine atom or a chlorine atom.

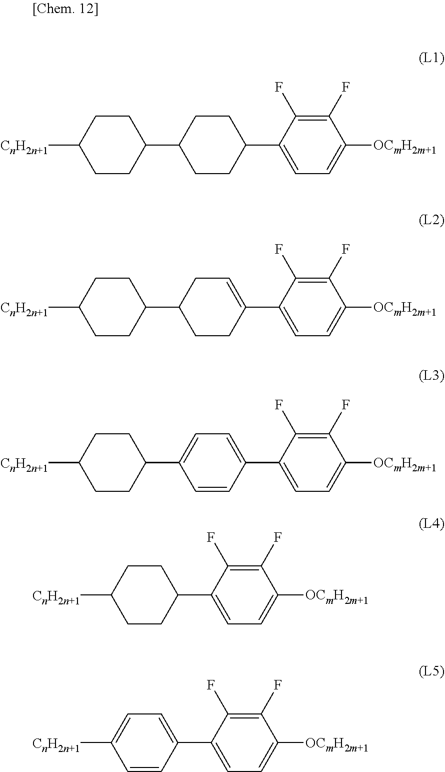

In the chemical formulae (L1) to (L5), m and n each independently represent an integer of 1 to 18.

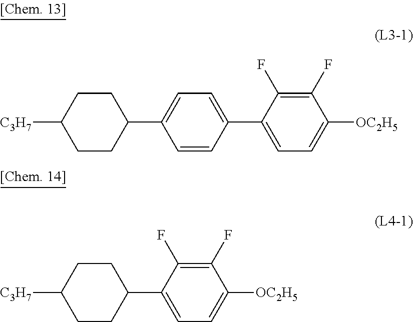

In the chemical formula (L), R represents a monovalent organic group, and is preferably a C3-C35 monovalent hydrocarbon group, more preferably a C7-C30 monovalent hydrocarbon group containing one or two C6 aromatic ring groups.

### <Alignment Film>

As used herein, the “alignment film” functions to control the alignment of the liquid crystal compound in the liquid crystal layer 30. When a voltage applied to the liquid crystal layer 30 is lower than the threshold voltage (including no-voltage application), the alignment of molecules of the liquid crystal compound in the liquid crystal layer 30 is controlled mainly by the function of the alignment film. In this state (hereinafter also referred to as an “initial alignment state”), the angle formed by the major axis of the liquid crystal compound relative to the surfaces of the first substrate 10 and the second substrate 20 is referred to as a “pre-tilt angle”. The “pre-tilt angle” as used herein indicates the degree of tilt of the liquid crystal compound from the direction parallel to the substrate surface. The angle parallel to the substrate surface is 0°, and the angle normal to the substrate is 90°.

The liquid crystal display device 1A of the present embodiment includes the alignment films 40a. Each alignment film 40a is the polymer layer 41 formed using the alignment agent A containing a polyamic acid and a polysiloxane. With the polyamic acid contained in the alignment agent A, it is possible to increase the adhesion strength between the alignment film 40a and the sealing material 50.

In the polyamic acid, every repeating unit in one molecule of the polymer may have an amic acid (amide acid) structure or some may not have an amic acid (amide acid) structure. Some repeating units in one molecule of the polymer may have an imide structure as some carboxyl groups of the amic acid (amide acid) are dehydrated and cyclized. When the polyamic acid includes some repeating units with an imide structure, the ratio of the number of repeating units with an imide structure to the number cE repeating units in one molecule of the polyamic acid, i.e., the imidization ratio of the polyamic acid in the alignment agent A (i.e., the polyamic acid before baking (pre-baking and post-baking) which is described later) is 10% or lower. The imidization ratio is calculated from the degree of disappearance of —CONH— group-derived peaks using Fourier transform infrared spectroscopy (FTIR). The imidization ratio of the polyamic acid after baking (pre-baking and post-baking), i.e., the imidization ratio of the polyamic acid in each alignment film 40a, is usually higher than 10% and may be about 50%, for example.

As shown in FIG. 1(b), the polymer layer 41 formed using the alignment agent A containing a polyamic acid and a polysiloxane has a bilayer structure including a layer 41a formed from the polyamic acid and a layer 41b formed from the polysiloxane. In the bilayer structure, the layer 41b formed from the polysiloxane is an upper layer which is adjacent to the liquid crystal layer 30, and the layer 41b formed from the polysiloxane is a lower layer which is adjacent to the first substrate 10 or the second substrate 20. Presumably, while the polysiloxane and the polyamic acid are mixed disorderly at the boundary between the upper layer and the lower layer of the bilayer structure, the amount of the polysiloxane gradually increases toward the liquid crystal layer 30, and the amount of the polyamic acid gradually increases toward the first substrate 10 or the second substrate 20.

The polyamic acid preferably has a structure represented by the following chemical formula (PA1):

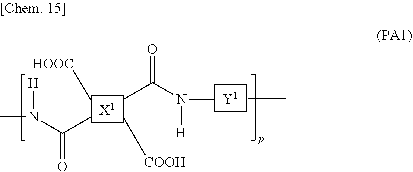

wherein X¹ represents a quadrivalent group; Y¹ represents a divalent group; and p represents an integer of 1 or greater.

In the chemical formula (PA1), X¹ represents a quadrivalent group, and is preferably a C4-C20 quadrivalent group having a ring structure, more preferably a quadrivalent group containing one to three C6 aromatic ring groups or one to three C4-C6 alicyclic groups. Two or more aromatic ring groups or alicyclic groups, when contained, may be bonded together directly or via a linking group, or may be condensed together. Examples of the linking group include C1-C5 hydrocarbon groups, —O—, —N═N—, —C≡C—, —CH═CH—, and —CO—CH═CH—.

Specific examples of X¹ include chemical structures represented by the following chemical formulae (X1-1) to (X1-12). At least one hydrogen atom in each structure may be replaced by a halogen group, a methyl group, or an ethyl group. X¹ is preferably a chemical structure represented by the following chemical formula (X1-1), (X1-7), or (X1-8).

The resistance of each alignment film 40a can be reduced by the use of a polyamic acid of the chemical formula (PA1) in which X¹ is represented by the following chemical formula (X1-1). A polyamic acid of the chemical formula (PA1) in which X¹ is represented by the following chemical formula (X1-7) is suitably used when alignment treatment is performed through degradation by ultraviolet light irradiation or when it is intended to increase the resistance of each alignment film 40a. The resistance of each alignment film 40a can be increased by the use of the polyamic acid of the chemical formula (PA1) in which X1 is represented by the following chemical formula (X1-8), as in the case of using the one in which X¹ is represented by the following chemical formula (X1-7), but the chemical structure represented by the following (X1-8) is more structurally stable than the chemical structure represented by the following (X1-7), and thus can stabilize the resistance of the alignment film 40a at a higher value.

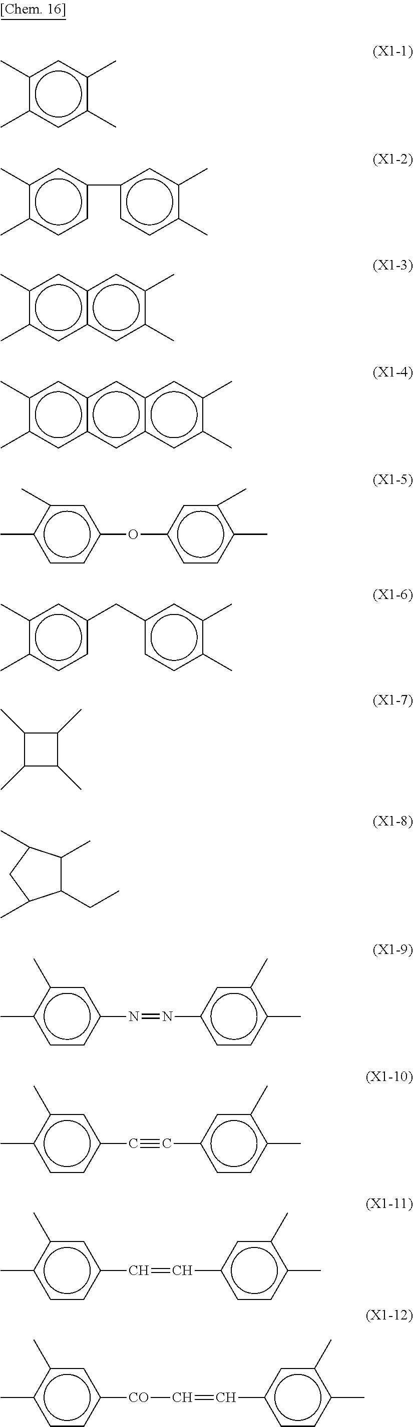

In the chemical formula (PA1), Y¹ represents a divalent group, which is preferably a C6-C20 divalent group having an aromatic ring, more preferably a divalent group containing one to three C6 aromatic ring groups. Two or more aromatic ring groups, when contained, may be bonded together directly or via a linking group, or may be condensed together. Examples of the linking group include C1-C5 hydrocarbon groups, —O—, —N═N—, —C≡C—, —CH═CH—, and —CO—CH═CH—.

Specific examples of Y¹ include chemical structures represented by the following chemical formulae (Y1-1) to (Y1-16). At least one hydrogen atom in each structure may be replaced by a halogen group, a methyl group, or an ethyl group. Y¹ is preferably a chemical structure represented by the following chemical formula (Y1-2), (Y1-8), or (Y1-16).

The resistance of each alignment film 40a can be adjusted to a suitable range by the use of a polyamic acid of the chemical formula (PA1) in which Y¹ is represented by the following chemical formula (Y1-2) or (Y1-16).

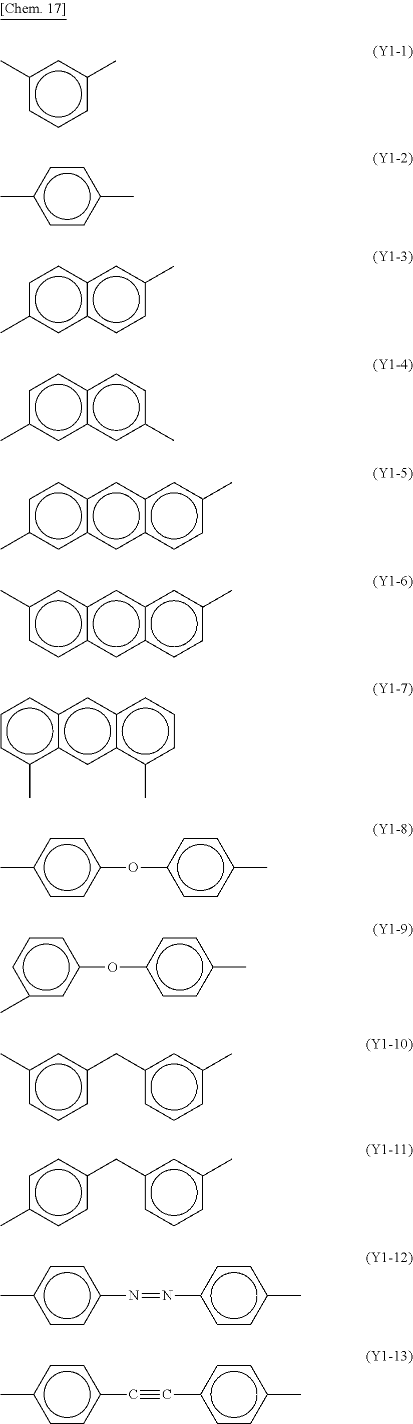

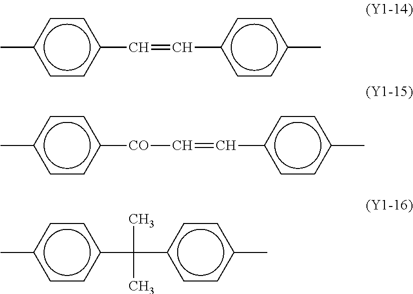

One molecule of the polyamic acid having a structure represented by the chemical formula (PA1) may contain one or more kinds of X¹ and one or more kinds of Y¹.

It is also preferred that a polyamic acid in the present embodiment has a structure represented by the following chemical formula (PA2). This embodiment allows a functional group having various functions such as a photoalignable functional group to be introduced into the polyamic acid.

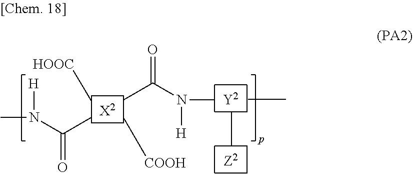

In the chemical formula (PA2), X² represents a quadrivalent group; Y² represents a trivalent group; Z² represents a monovalent group; and p represents an integer of 1 or greater.

In the chemical formula (PA2), X² represents a quadrivalent group, and is preferably a C4-C20 quadrivalent group having a ring structure, more preferably a quadrivalent group containing one to three C6 aromatic ring groups or one to three C4-C6 alicyclic groups. Two or more aromatic ring groups or alicyclic groups, when contained, may be bonded together directly or via a linking group, or may be condensed together. Examples of the linking group include C1-C5 hydrocarbon groups, —O—, —N═N—, —C≡C—, —CH═CH—, and —CO—CH═CH—.

Specific examples of X² include chemical structures represented by the following chemical formulae (X2-1) to (X2-12). At least one hydrogen atom in each structure may be replaced by a halogen group, a methyl group, or an ethyl group. X² is preferably a chemical structure represented by the following chemical formula (X2-8). The resistance of each alignment film 40a can be stabilized at a high value by the use of a polyamic acid of the chemical formula (PA2) in which X² is represented by the following chemical formula (X2-8).

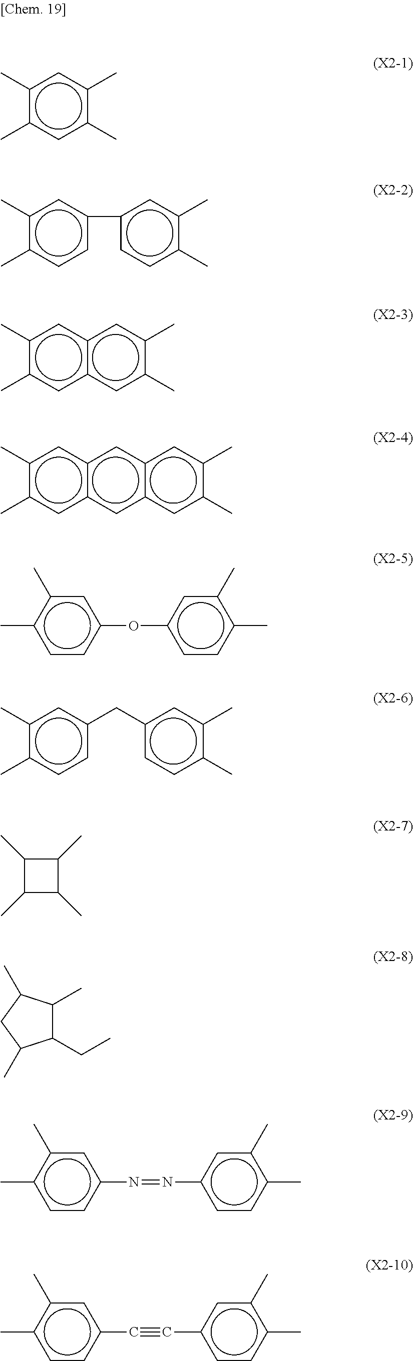

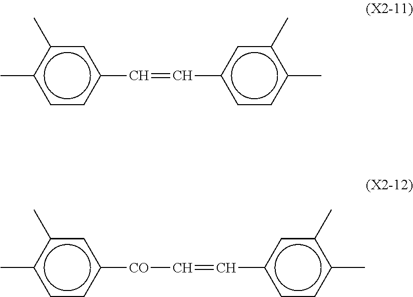

In the chemical formula (PA2), Y² represents a trivalent group, and is preferably a C6-C20 trivalent group having an aromatic ring, more preferably a trivalent group containing one to three C6 aromatic ring groups. Two or more aromatic ring groups, when contained, may be bonded together directly or via a linking group, or may be condensed together. Examples of the linking group include C1-C5 hydrocarbon groups, —O—, —N═N—, —C≡C—, —CH═CH—, and —CO—CH═CH—.

Specific examples of Y² include chemical structures represented by the following chemical formulae (Y2-1) to (Y2-24). At least one hydrogen atom in each structure may be replaced by a halogen group, a methyl group, or an ethyl group. Y² is preferably a chemical structure represented by the following chemical formula (Y2-1) or (Y2-2). This embodiment allows the resistance of each alignment film 40a to be adjusted to a suitable range.

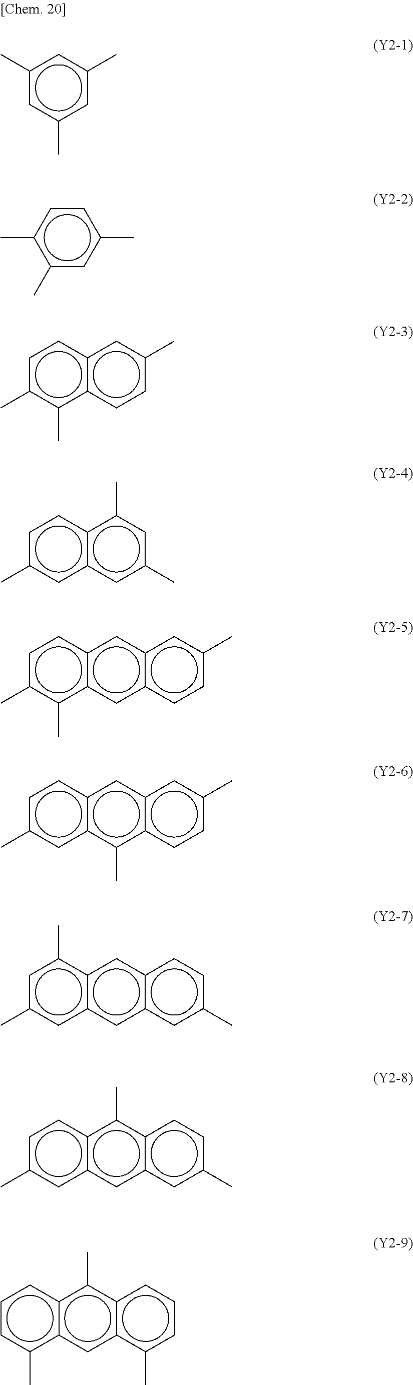

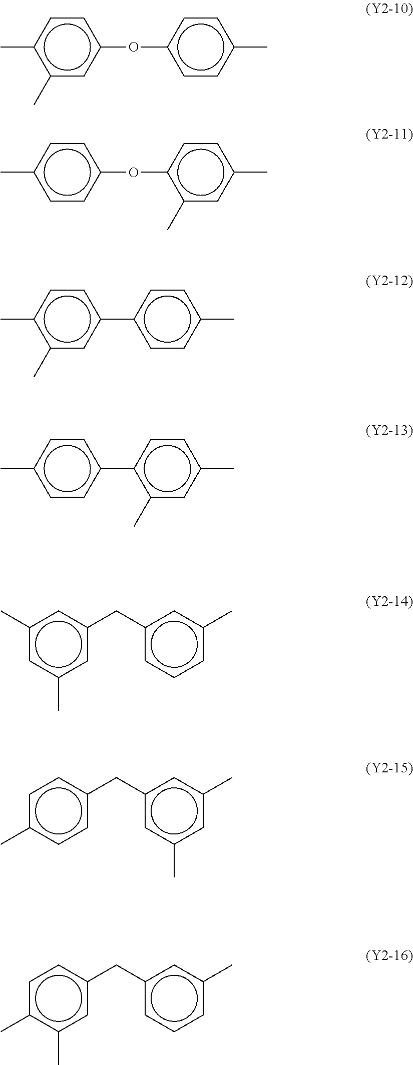

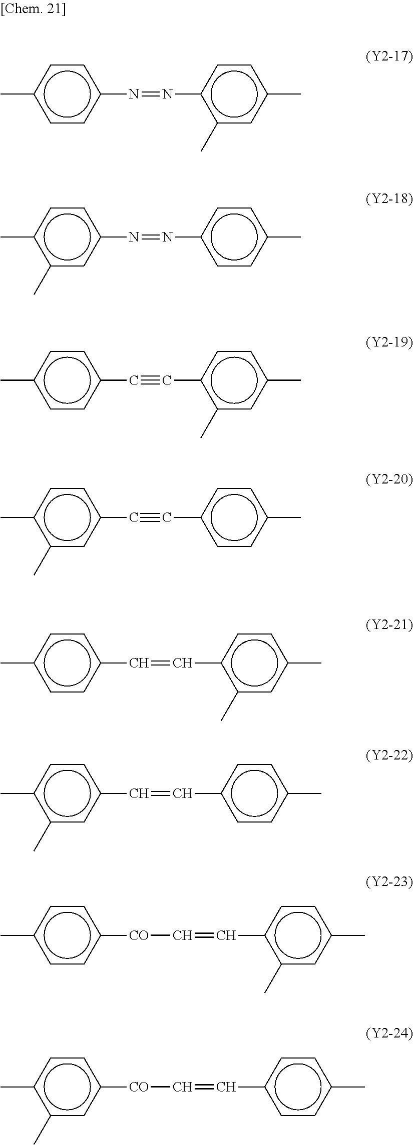

In the chemical formula (PA2), Z² represents a monovalent group, and is preferably a monovalent group represented by —(R^{Z})_{d}— (COO—Z)ₑ or —(R^{Z})_{d}— (OCO—Z)ₑ, wherein R^{Z} represents a C1-C5 (e+1)-valent group; d represents 0 or 1; e represents 1 or 2; and Z represents a C1-C30 monovalent group or a hydrogen atom. At least one hydrogen atom in each structure may be replaced by a halogen group, a methyl group, or an ethyl group.

Specific examples of Z² include chemical structures represented by the following chemical formulae (Z2-1) to (Z2-42). At least one hydrogen atom in each structure may be replaced by a halogen group, a methyl group, or an ethyl group. Z² is preferably a chemical structure represented by the following chemical formula (Z2-9) or (Z2-38). This embodiment can increase the voltage holding ratio (VHR) and minimize the residual DC (rDC).

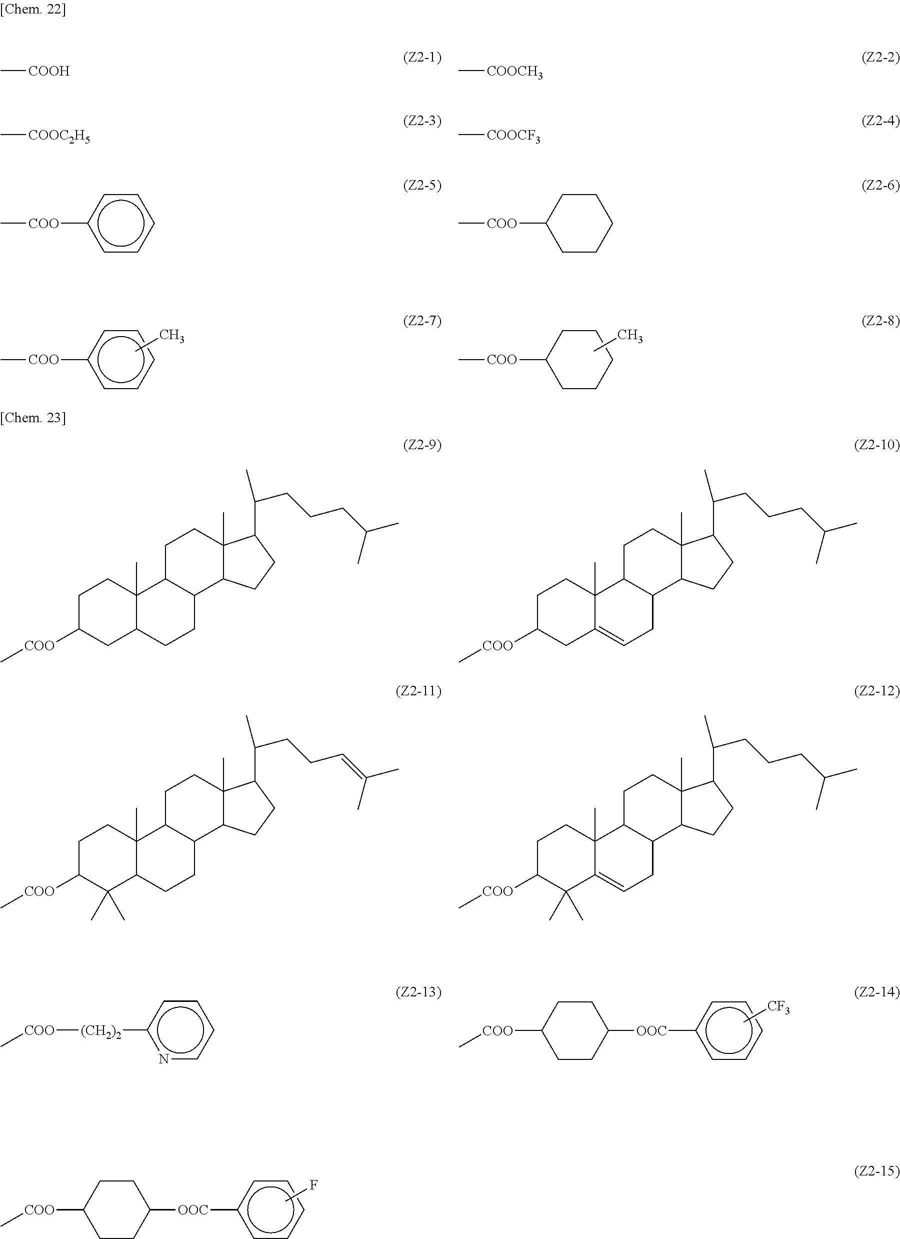

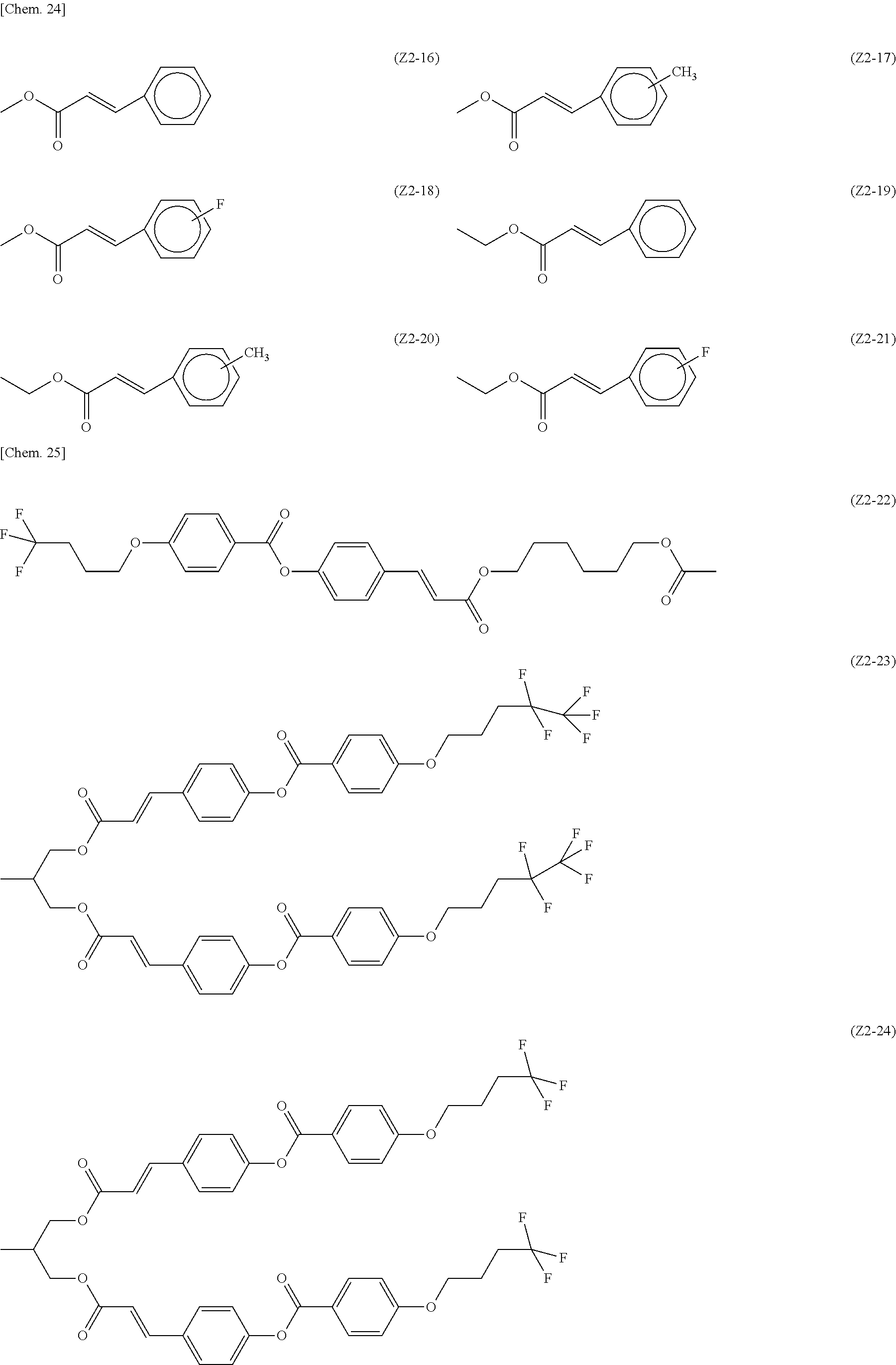

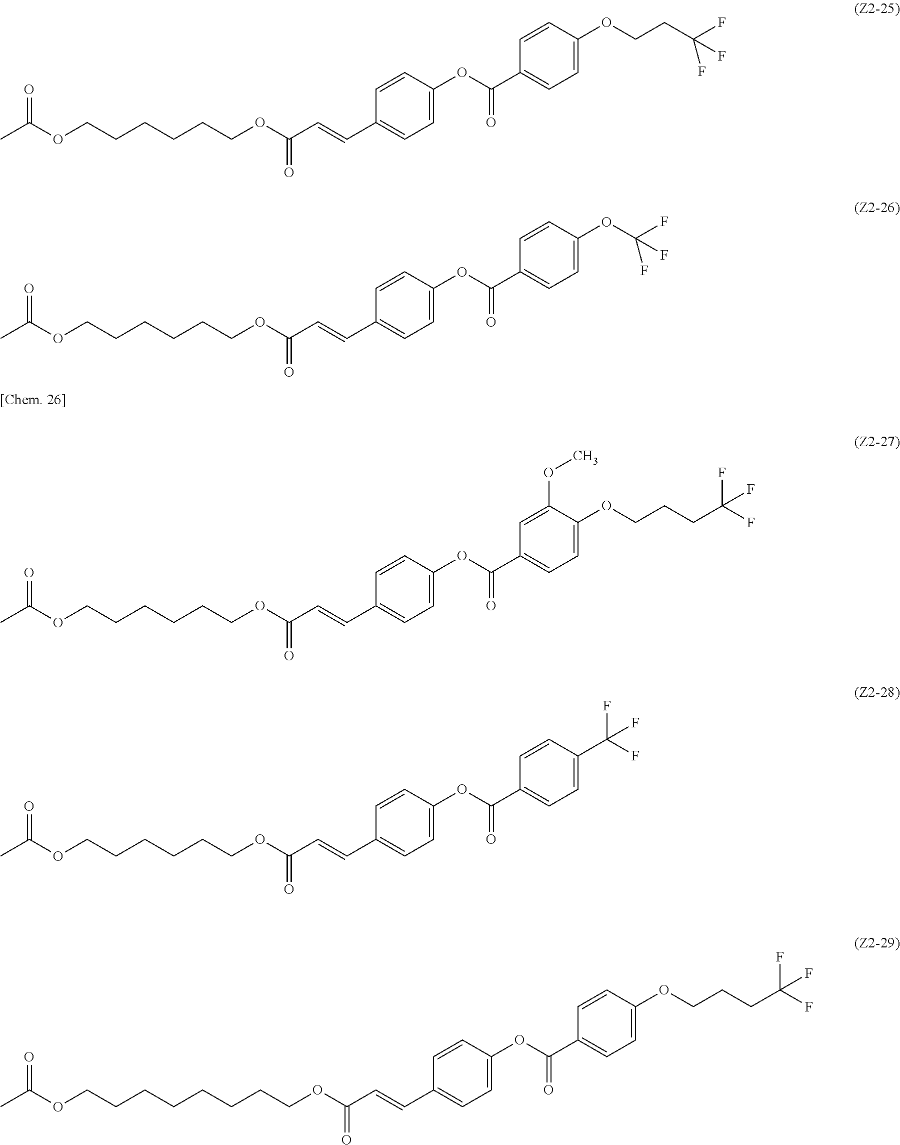 [SMILES: CC(=O)OCCCCCCOC(=O)/C=C/c1ccc(OC(=O)c2ccc(OCCC(F)(F)F)cc2)cc1 ; CC(=O)OCCCCCCOC(=O)/C=C/c1ccc(OC(=O)c2ccc(OC(F)(F)F)cc2)cc1 ; COc1cc(C(=O)Oc2ccc(/C=C/C(=O)OCCCCCCOC(C)=O)cc2)ccc1OCCCC(F)(F)F ; CC(=O)OCCCCCCOC(=O)/C=C/c1ccc(OC(=O)c2ccc(C(F)(F)F)cc2)cc1 ; CC(=O)OCCCCCCCCOC(=O)/C=C/c1ccc(OC(=O)c2ccc(OCCCC(F)(F)F)cc2)cc1]

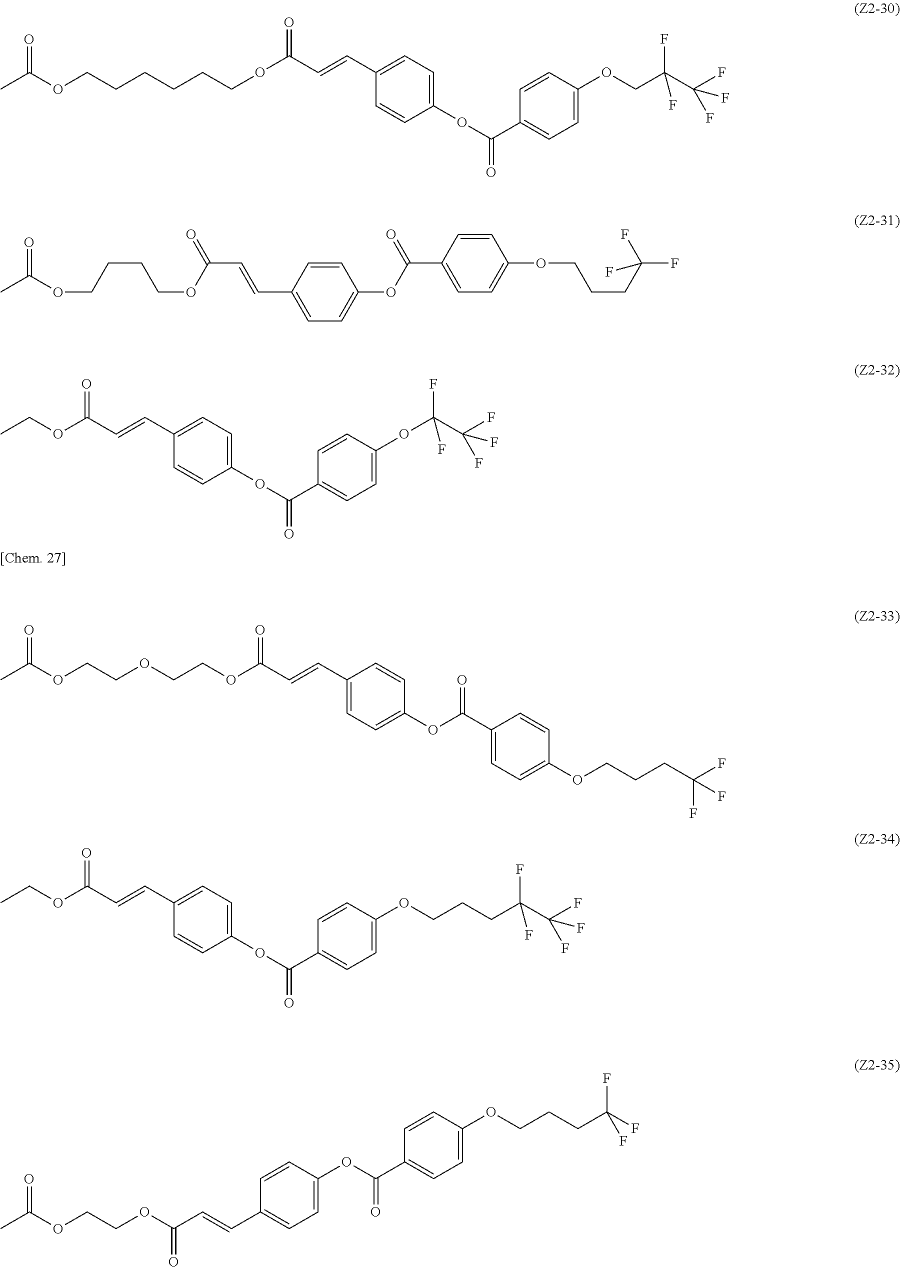 [SMILES: CC(=O)OCCCCCCOC(=O)/C=C/c1ccc(OC(=O)c2ccc(OCC(F)(F)C(F)(F)F)cc2)cc1 ; CC(=O)OCCCCOC(=O)/C=C/c1ccc(OC(=O)c2ccc(OCCCC(F)(F)F)cc2)cc1 ; CCOC(=O)/C=C/c1ccc(OC(=O)c2ccc(OC(F)(F)C(F)(F)F)cc2)cc1 ; CC(=O)OCCOCCOC(=O)/C=C/c1ccc(OC(=O)c2ccc(OCCCC(F)(F)F)cc2)cc1 ; CCOC(=O)/C=C/c1ccc(OC(=O)c2ccc(OCCCC(F)(F)C(F)(F)F)cc2)cc1 ; CC(=O)OCCOC(=O)/C=C/c1ccc(OC(=O)c2ccc(OCCCC(F)(F)F)cc2)cc1]

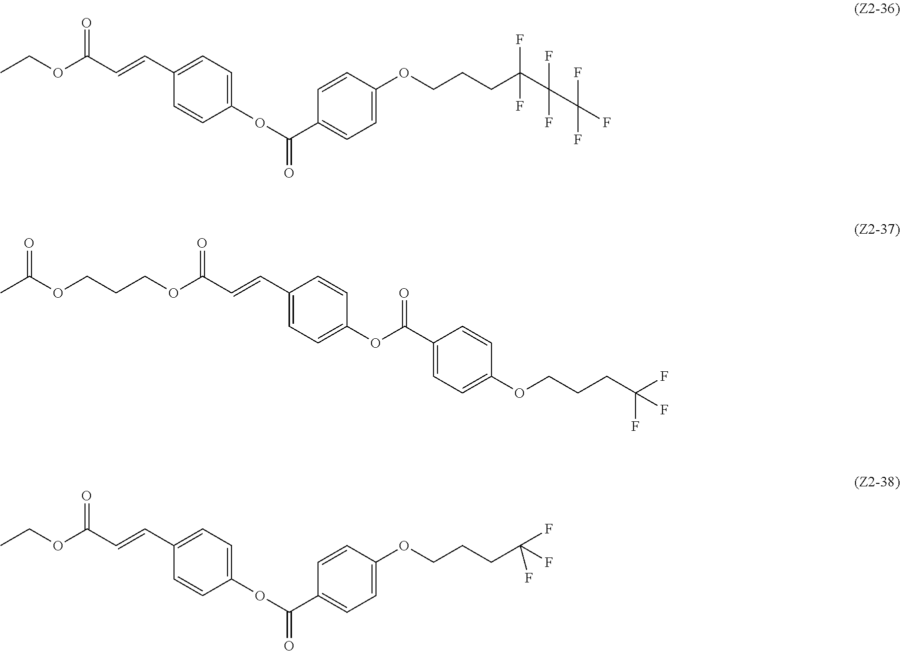 [SMILES: CCOC(=O)/C=C/c1ccc(OC(=O)c2ccc(OCCCC(F)(F)C(F)(F)C(F)(F)F)cc2)cc1 ; CC(=O)OCCCOC(=O)/C=C/c1ccc(OC(=O)c2ccc(OCCCC(F)(F)F)cc2)cc1 ; CCOC(=O)/C=C/c1ccc(OC(=O)c2ccc(OCCCC(F)(F)F)cc2)cc1]

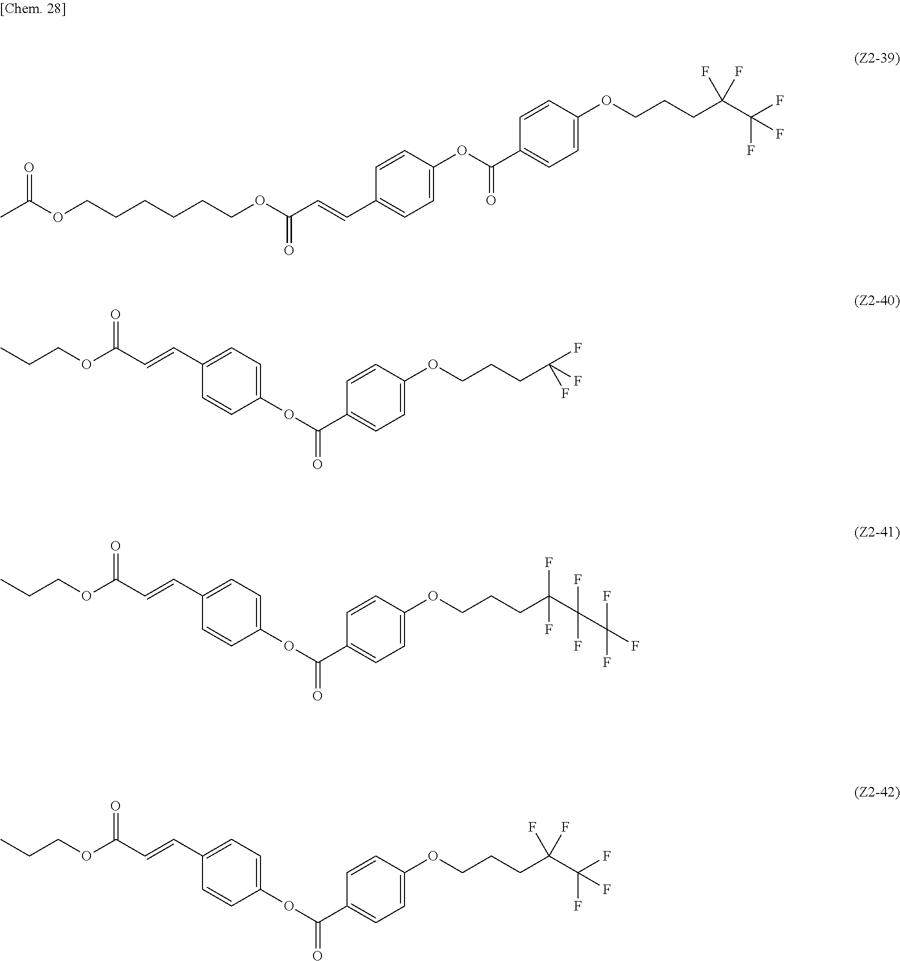 [SMILES: CC(=O)OCCCCCCOC(=O)/C=C/c1ccc(OC(=O)c2ccc(OCCCC(F)(F)C(F)(F)F)cc2)cc1 ; CCCOC(=O)/C=C/c1ccc(OC(=O)c2ccc(OCCCC(F)(F)F)cc2)cc1 ; CCCOC(=O)/C=C/c1ccc(OC(=O)c2ccc(OCCCC(F)(F)C(F)(F)C(F)(F)F)cc2)cc1 ; CCCOC(=O)/C=C/c1ccc(OC(=O)c2ccc(OCCCC(F)(F)C(F)(F)F)cc2)cc1]

One molecule of the polyamic acid having a structure represented by the chemical formula (PA2) may contain one or more kinds of X², one or more kinds of Y², and or more kinds of Z².

The alignment agent A may contain both the polyamic acid having a structure represented by the chemical formula (PA1) and the polyamic acid having a structure represented by the chemical formula (PA2).

The weight average molecular weight of the polyamic acid for use in the present embodiment is preferably 10,000 to 1,000,000, more preferably 30,000 to 200,000. The polyamic acid having a weight average molecular weight in the above range can be easily formed into a film having a desired uniform thickness. When the weight average molecular weight of the polyamic acid is too small, the polyamic acid cannot be easily formed into a film having a desired thickness. A film that is too thick may not only have an uneven thickness but also significant irregularities on its surface.

The polysiloxane for use in the present embodiment is a polymer having a siloxane structure. The polysiloxane preferably contains a group that forms a chemical bond with a carboxyl group of the polyamic acid, and more preferably has at least one functional group selected from the group consisting of an epoxy group and an isocyanate group. Polysiloxanes have a small molecular weight and a flexible structure, and may thus dissolve into the liquid crystal layer 30. However, when the polysiloxane contains a group that forms a chemical bond with a carboxyl group of the polyamic acid, dissolution of the polysiloxane into the liquid crystal layer 30 can be suppressed, which further suppresses the occurrence of a bright dot.

For example, when the polysiloxane contains an epoxy group, heating the alignment agent A containing a polysiloxane and a polyamic acid causes a reaction as shown in the following formula i, resulting in a chemical bond between the polysiloxane and the polyamic acid. This can suppress dissolution of the polysiloxane into the liquid crystal layer 30, further suppressing the occurrence of a bright dot.

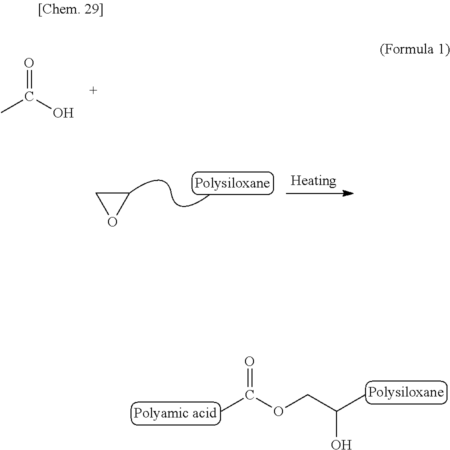

The polysiloxane preferably has a structure represented by the following chemical formula (PS1) or (PS2):

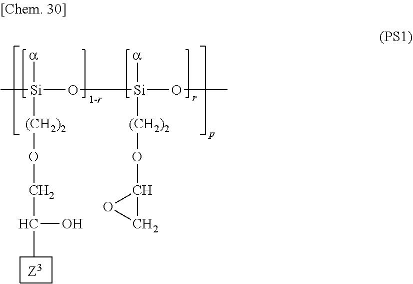

wherein Z³ represents a monovalent group; α represents a hydrogen atom, a hydroxyl group, or a C1-C5 alkoxy group; p represents an integer of 1 or greater; and r represents a real number of 0<r≤0.6,

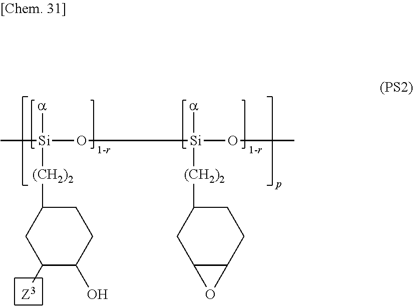

wherein Z³ represents a monovalent group; a represents a hydrogen atom, a hydroxyl group, or a C1-C5 alkoxy group; p represents an integer of 1 or greater; and r represents a real number of 0<r≤0.6.

In each of the chemical formulae (PS1) and (PS2), Z³ represents a monovalent group, and is preferably a group represented by —COO—Z^{S} or —OCO—Z^{S}, wherein Z^{S} represents a C5-C25 monovalent group. At least one hydrogen atom in each structure may be replaced by a halogen group, a methyl group, or an ethyl group.

Specific examples of Z³ include chemical structures represented by the following chemical formulae (Z3-1) to (Z3-8). At least one hydrogen atom in each structure may be replaced by a halogen group, a methyl group, or an ethyl group. Z³ is preferably a chemical structure represented by the following chemical formula (Z3-1) or (Z3-6).

With use of a polysiloxane in which Z³ is represented by the following chemical formula (Z3-1), it is possible to vertically align the molecules of the liquid crystal compound. With the use of a polysiloxane in which Z³ is represented by the following chemical formula (Z3-6), it is possible to horizontally align the molecules of the liquid crystal compound.

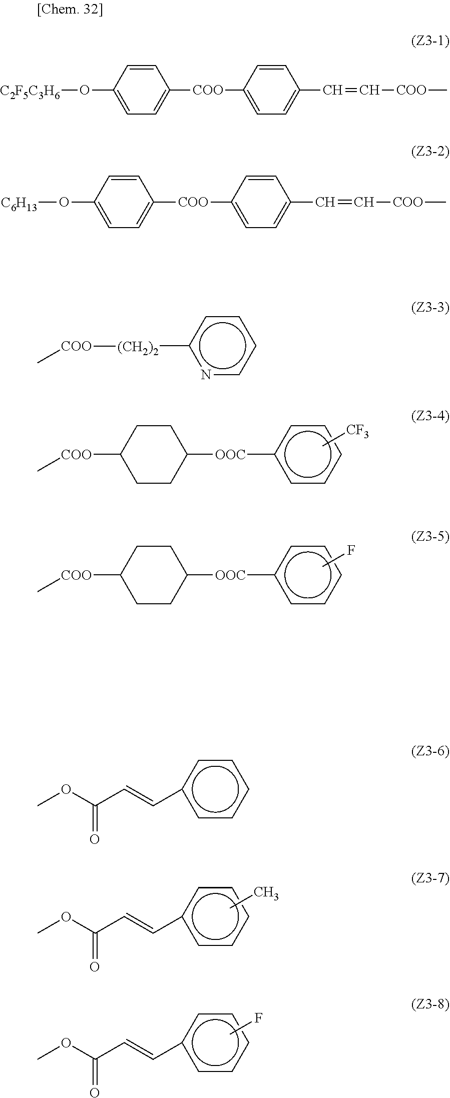

In each of the chemical formulae (PS1) and (PS2), α represents a hydrogen atom, a hydroxyl group, or a C1-C5 alkoxy group. Examples of the C1-C5 alkoxy group include —OCH₃, —OC₂H₅, —OC₃H₇, —OC₄H₉, and —OC₅H₁₁, which may be a linear structure, a branched structure, or a ring structure. In each of the chemical formulae (PS1) and (PS2), α preferably represents a hydrogen atom, a hydroxyl group, a methoxy group, or an ethoxy group.

In each of the chemical formulae (PS1) and (PS2), α represents a real number of 0<r≤0.6, preferably 0.3≤r≤0.6, more preferably 0.4≤r≤0.5. This embodiment allows the polysiloxane to be more effectively located near the interface between the liquid crystal layer 30 and the alignment film 40a and near the interface between the alignment film 40a and the sealing material 50, further suppressing the occurrence of a bright dot.

One molecule of the polysiloxane having a structure represented by the chemical formula (PS1) or (PS2) may contain one or more kinds of Z³ and one or more kinds of α.

The alignment agent A may contain both the polysiloxane having a structure represented by the chemical formula (PS1) and the polysiloxane having a structure represented by the chemical formula (PS2).

The weight average molecular weight of the polysiloxane for use in the present embodiment is preferably 10,000 to 1,000,000, more preferably 30,000 to 200,000. The polysiloxane having a weight average molecular weight in the above range can be easily formed into a film having a desired uniform thickness. When the weight average molecular weight of the polysiloxane is too small, the polysiloxane cannot be easily formed into a film having a desired thickness. A film that is too thick may not have only an uneven thickness but also significant irregularities on its surface.

The weight ratio of the polysiloxane to the polyamic acid contained in the alignment agent A (polysiloxane:polyamic acid) is preferably 0.5:9.5 to 3:7, more preferably 1:9 to 2:8.

The alignment film 40a may impart any pre-tilt angle to the liquid crystal compound, and the alignment film 40a may be a horizontal alignment film that substantially horizontally aligns the liquid crystal compound in the liquid crystal layer 30, or a vertical alignment film that substantially vertically aligns the liquid crystal compound in the liquid crystal layer 30. In the case of the horizontal alignment film and a horizontal alignment mode, the “substantially horizontally” preferably refers to a state where the pre-tilt angle is 0° or more and 5° or less. When the display mode is an IPS mode or an FFS mode, the pre-tilt angle is preferably 0° to provide good viewing angle characteristics. When the display mode is a TN mode, the pre-tilt angle is set to about 2°, for example, due to restrictions of the mode. In the case of the vertical alignment film and a vertical alignment mode, the “substantially vertically” preferably refers to a state where the pre-tilt angle is 85° or more and 90° or less. As described above, the present embodiment is applicable to both the horizontal alignment mode and the vertical alignment mode.

When the alignment film 40a is subjected to rubbing treatment to form a horizontal alignment film, Z² in the chemical formula (PA2) preferably has a structure represented by any of the chemical formulae (Z2-1) to (Z2-8). When the alignment film 40a is subjected to the rubbing treatment to form a vertical alignment film, Z² in the chemical formula (PA2) preferably has a structure represented by any one of the chemical formula (Z9-1) to (Z2-15).

When the alignment film 40a is subjected to photoalignment treatment to form a horizontal alignment film, Z² in the chemical formula (PA2) preferably has a structure represented by any of the chemical formulae (Z2-16) to (Z2-21). When the alignment film 40a is subjected to the photoalignment treatment to form a vertical alignment film, Z² in the chemical formula (PA2) preferably has a structure represented by any of the chemical formulae (Z2-22) to (Z2-42).

The thickness of the alignment film 40a is not particularly limited and can be appropriately set, but it is preferably 50 nm or more and 200 nm or less, more preferably 60 nm or more and 150 nm or less. When the alignment film 40a is thinner than 50 nm, it may not be possible to form a uniform alignment film on the entire substrate. When the alignment film 40a is thicker than 200 nm, the alignment film tends to have irregularities on its surface, and the molecules of the liquid crystal compound may have various tilt angles, causing display unevenness.

### <Sealing Material>

The sealing material 50 of the present embodiment achieves adhesion between the first substrate 10 and the second substrate 20, and is a cured product of an epoxy resin-containing sealant. The sealing material 50 is disposed to surround the liquid crystal layer 30. The epoxy resin may be photocurable or thermally curable, but a photocurable resin is preferred, and an ultraviolet-curable epoxy resin is more preferred.

Examples of the epoxy resin include phenol novolac type epoxy resins, cresol novolac type epoxy resins, biphenyl novolac type epoxy resins, trisphenol novolac type epoxy resins, dicyclopentadiene novolak type epoxy resins, bisphenol A type epoxy resins, bisphenol F type epoxy resins, 2,2′-diallyl bisphenol A type epoxy resins, bisphenol S type epoxy resins, hydrogenated bisphenol A type epoxy resins, propylene oxide-added bisphenol A type epoxy resins, biphenyl type epoxy resins, naphthalene type epoxy resins, resorcinol type epoxy resins, and glycidyl amines.

As for commercially available products of the epoxy resin, examples of the phenyl novolac type epoxy resins include NC-3000S (available from Nippon Kayaku Co., Ltd.); examples of the trisphenol novolac type epoxy resins include EPPN-501H and EPPN-501H (both available from Nippon Kayaku Co., Ltd.); examples of the dicyclopentadiene novolak type epoxy resins include NC-7000L (available from Nippon Kayaku Co., Ltd.); examples of the bisphenol A type epoxy resins include Epiclon 840S and Epiclon 850CRP (both available from DIC Corporation); examples of the bisphenol F type epoxy resins include Epikote 807 (available from Japan Epoxy Resins Co. Ltd.) and Epiclon 830 (available from DIC Corporation); examples of the 2,2′-diallyl bisphenol A type epoxy resins include RE310NM (available from Nippon Kayaku Co., Ltd.); examples of the hydrogenated bisphenol type epoxy resins include Epiclon 7015 (available from DIC Corporation); examples of the propylene oxide-added bisphenol A type epoxy resins include Epoxy Ester 3002A (available from Kyoeisha Chemical Co., Ltd.); examples of the biphenyl type epoxy resins include Epikote YX-4000H and YL-6121H (both available from Japan Epoxy Resins Co. Ltd.); examples of the naphthalene type epoxy resins include Epiclon HP-4032 (available from DIC Corporation); examples of the resorcinol type epoxy resins include Denacol EX-201 (available freom Nagase ChemteX Corporation); and examples of the glycidyl amines include Epiclon 430 (available from DIC Corporation), and Epikote 630 (available from Japan Epoxy Resins Co. Ltd.).

In addition, as the epoxy resin for use in the present embodiment, an epoxy/(meth)acrylic resin having at least one (meth)acrylic group and at least one epoxy group in one molecule can also be suitably used.

Examples of the epoxy/(meth)acrylic resin include compounds that can be obtained by reacting some epoxy groups of the epoxy resin with a (meth)acrylic acid in the presence of a basic catalyst according to a usual method; compounds that can be obtained by reacting 1 mol of a bi- or higher functional isocyanate with ½ mol of a (meth)acryl monomer having a hydroxy group and subsequently with ½ mol of a glycidol; and compounds that can be obtained by reacting a (meth)acrylate having an isocyanate group with a glycidol. Examples of commercial products of the epoxy/(meth)acrylic resin include UVAC 1561 (available from Daicel-UCB Co. Ltd.).

### <Other Configuration>

A polarizing plate (linear polarizer) may be disposed on each of the first substrate 10 and the second substrate 20, on the sides opposite to the liquid crystal layer 30. Typically, examples of the polarizing plate include a polyvinyl alcohol (PVA) film in which an anisotropic material such as a dichroic iodine complex is adsorbed and aligned. Usually, a protection film such as a triacetyl cellulose film is laminated on each side of the PVA film for actual applications. An optical film such as a phase difference film may be disposed between the polarizing plate and the first substrate 10 or the second substrate 20.

The liquid crystal display device 1A of the present embodiment may include a backlight unit. Any backlight unit may be used as long as it emits light including visible light. It may be one that emits light including only visible light, or that emits light including both visible light and ultraviolet light. To allow the liquid crystal display device to perform color display, the backlight unit preferably emits white light. As the light source of the backlight unit, a light emitting diode (LED) is suitably used, for example.

The liquid crystal display device 1A of the present embodiment may further include, in addition to those described above, multiple members such as external circuits including a tape carrier package (TCP) and a PCB (printed circuit board); and a bezel (frame). Some members may be incorporated into other members. Members other than those that have been described are not particularly limited, and those commonly used in the liquid crystal display device field can be used. Thus, descriptions thereof are omitted.

The display mode of the liquid crystal display device 1A is not particularly limited. Examples include a twisted nematic (TN) mode, an electrically controlled birefringence (ECB) mode, an in-plane switching (IPS) mode, a fringe field switching (FFS) mode, a vertical alignment (VA) mode, and a vertical alignment twisted nematic (VATN) mode. The FFS mode, the VATN mode, or the VA mode is preferred. The VA mode is particularly preferably a multi-domain vertical alignment (MVA) mode. The VATN mode is preferably a 4D-VATN (4 domain-VATN) mode, more preferably a 4D-VATN mode in which the photoalignment treatment is performed by ultraviolet light irradiation.

### Embodiment 2

A liquid crystal display device of Embodiment 2 is a liquid crystal display device having the same configuration as in Embodiment 1, except that the alignment films 40a in the liquid crystal display device 1A of Embodiment 1 are changed. In the present embodiment, features specific to the present embodiment are mainly described, and descriptions of the same features as in Embodiment 1 are suitably omitted.

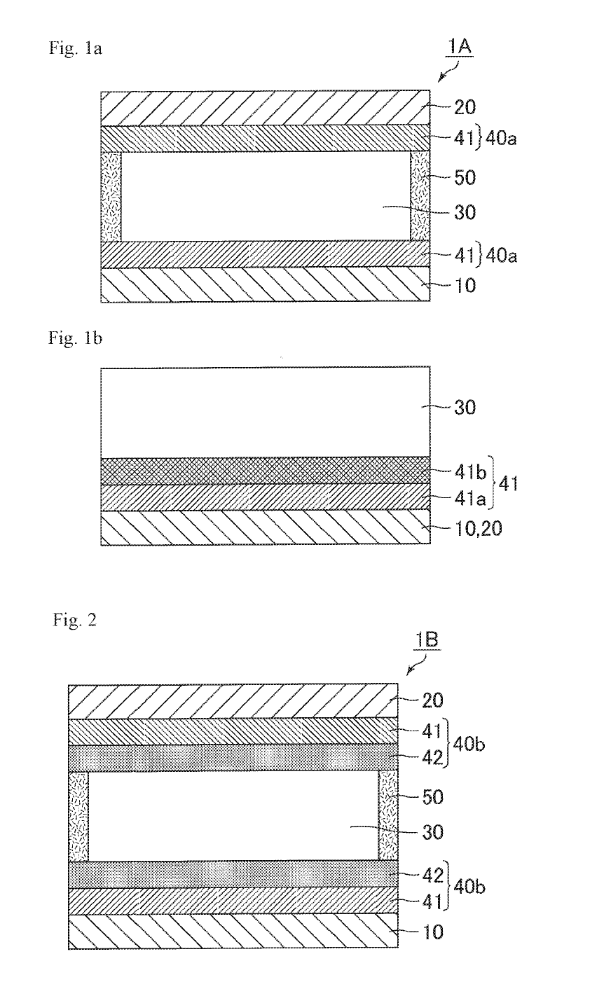

FIG. 2 is a schematic cross-sectional view of a liquid crystal display device of Embodiment 2. As shown in FIG. 2, a liquid crystal display device 1B of the present embodiment includes: the first substrate 10; the second substrate 20 disposed opposite to the first substrate 10; the liquid crystal layer 30 disposed between the first substrate 10 and the second substrate 20; an alignment film 40b disposed on each of the first substrate 10 and the second substrate 20, on the sides facing the liquid crystal layer 30; and the sealing material 50 to achieve adhesion between the first substrate 10 and the second substrate 20. The liquid crystal layer 30 contains a liquid crystal material, and the liquid crystal material contains an alkoxy group-containing liquid crystal compound and exhibits a liquid crystal phase at −10° C. or higher and 80° C. or lower. The sealing material 50 is a cured product of an epoxy resin-containing sealant. Each alignment film 40b contains a silane coupling agent chemically adsorbed onto a surface of the polymer layer 41 formed using an alignment agent B containing a polyamic acid and a polysiloxane. The alignment film 40b corresponds to the first alignment film or the second alignment film, and the alignment agent B corresponds to the first alignment agent or the second alignment agent. A layer formed using the silane coupling agent adsorbed onto the surface of the polymer layer 41 formed using the alignment agent B is also referred to as a coupling layer 42. In other words, each alignment film 40b includes the coupling layer 42 on the surface of the polymer layer 41 formed using the alignment agent B containing a polyamic acid and a polysiloxane.

In order to suppress contact and incorporation of an acid (carboxyl groups of the polyamic acid) with or into the epoxy resin contained in the sealing material 50, the present embodiment uses each alignment film 40b including the coupling layer 42 on the surface of the polymer layer 41 formed using the alignment agent B containing a polyamic acid and a polysiloxane so as to significantly reduce the number of the carboxyl groups near the interface between the liquid crystal layer 30 and the alignment film 40b and near the interface between the alignment film 40b and the sealing material 50. This can suppress the occurrence of a bright dot. The coupling layer 42 constituting the alignment film 40b is described in detail below.

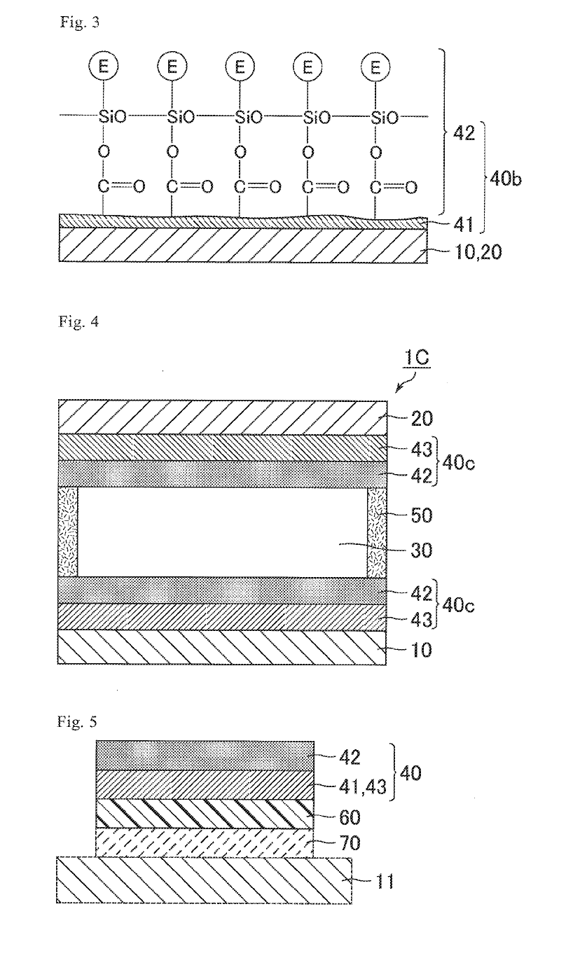

FIG. 3 is an enlarged schematic cross-sectional view of the liquid crystal display device of Embodiment 2. As shown in FIG. 3, in the present embodiment, the coupling layer 42 is disposed on the polymer layer 41 formed using the alignment agent B, on the side facing the liquid crystal layer 30. An end E of the silane coupling agent is present on the side facing the liquid crystal layer 30. It is possible to significantly reduce the number of the carboxyl groups near the interface of the alignment film 40a, even in the case where each alignment film 40a includes only the polymer layer 41 formed using the alignment agent A, as in the liquid crystal display device 1A of Embodiment 1. In order to further reduce the number of residual carboxyl groups near the interface, each alignment film 40b of the present embodiment includes the coupling layer 42 on the polymer layer 41 formed using the alignment agent B, on the side facing the liquid crystal layer 30. In other words, each alignment film 40b in the present embodiment is an alignment film in which the polymer layer 41 formed using the alignment agent B is surface-treated with the silane coupling agent.

The silane coupling agent for use in the present embodiment is preferably a compound represented by the following chemical formula (SC1), more preferably a compound represented by the following chemical formula (SC2) or (SC3), still more preferably a compound represented by the following chemical formula (SC4) or (SC5). The presence of the coupling layer 42 on each polymer layer 41 may change the alignment azimuth and/or tilt angle of the liquid crystal compound, but such change can be avoided or minimized with the silane coupling agent as described above.

[Chem. 33]

(Z)₃Si—(CR¹₂)ₐ—CR²₃ (SC1)

In the chemical formula (SC1), each Z independently represents a chlorine atom, a methoxy group, or an ethoxy group; each R¹ independently represents a hydrogen atom or a halogen atom; each R² independently represents a hydrogen atom or a halogen atom; and a represents an integer of 0 to 17.

[Chem. 34]

(Z)₃Si—(CH₂)ₐ—CF₃ (SC2)

[Chem. 35]

(Z)₃Si—(CH₂)_{b}—C₂F₅ (SC3)

In the chemical formulae (SC2) and (SC3), each Z independently represents a chlorine atom, a methoxy group, or an ethoxy group; a represents an integer of 0 to 17; and b represents an integer of 0 to 16.

[Chem. 36]

(OEt)₃Si—(CH₂)—CH₃ (SC4)

[Chem. 37]

(OEt)₃Si—(CH₂)₁₁—CF₃ (SC5)

In the present embodiment, the alignment film 40b may impart any pre-tilt angle to the liquid crystal compound, and the alignment film 40b may be a horizontal alignment film that substantially horizontally aligns the liquid crystal compound in the liquid crystal layer 30, or a vertical alignment film that substantially vertically aligns the liquid crystal compound in the liquid crystal layer 30.

The thickness of the alignment film 40b is not particularly limited and can be appropriately set, but it is preferably 50 nm or more and 200 nm or less, more preferably 60 nm or more and 150 nm or less. When the alignment film 40b is thinner than 50 nm, it may not be possible to form a uniform alignment film on the entire substrate. When the alignment film 40b is thicker than 200 nm, the alignment film tends to have irregularities on its surface, and the molecules of the liquid crystal compound may have various tilt angles, causing display unevenness.

The polymer layer 41 formed using the alignment agent B in the present embodiment and its preferred embodiments are the same as the alignment film 40a formed using the alignment agent A in Embodiment 1 and its preferred embodiments. In the present embodiment, the polyamic acid and the polysiloxane contained in the alignment agent B can be the same as those contained in the alignment agent A of Embodiment 1. Preferred polyamic acids and preferred polysiloxanes for use in the alignment agent B are the same as those mentioned in Embodiment 1.

### Embodiment 3

A liquid crystal display device of Embodiment 3 is a liquid crystal display device having the same configuration as in Embodiment 1, except that the alignment films 40a in the liquid crystal display device 1A of Embodiment 1 are changed. In the present embodiment, features specific to the present embodiment are mainly described, and descriptions of the same features as in Embodiment 1 are suitably omitted.

FIG. 4 is a schematic cross-sectional view of a liquid crystal display device of Embodiment 3. As shown in FIG. 4, a liquid crystal display device 1C of the present embodiment includes: the first substrate 10; the second substrate 20 disposed opposite to the first substrate 10; the liquid crystal layer 30 disposed between the first substrate 10 and the second substrate 20; an alignment film 40c disposed on each of the first substrate 10 and the second substrate 20, on the sides facing the liquid crystal layer 30; and the sealing material 50 to achieve adhesion between the first substrate 10 and the second substrate 20. The liquid crystal layer 30 contains a liquid crystal material, and the liquid crystal material contains an alkoxy group-containing liquid crystal compound and exhibits a liquid crystal phase at −10° C. or higher and 80° C. or lower. The sealing material 50 is a cured product of an epoxy resin-containing sealant. Each alignment film 40c contains a silane coupling agent chemically adsorbed onto a surface of the polymer layer 43 formed using the alignment agent C containing a polyamic acid. The alignment film 40c corresponds to the first alignment film or the second alignment film, and the alignment agent C corresponds to the first alignment agent or the second alignment agent. A layer formed using a silane coupling agent adsorbed onto the surface of each polymer layer 43 formed using the alignment agent C is also referred to as a coupling layer 42. In other words, each alignment film 40c includes the coupling layer 42 on the surface of the polymer layer 43 formed using the alignment agent C containing a polyamic acid.

In order to suppress contact and incorporation of an acid (carboxyl groups of the polyamic acid) with or into the epoxy resin contained in the sealant, the present embodiment uses each alignment film 40c including the coupling layer 42 on the surface of the polymer layer 43 formed using the alignment agent C containing a polyamic acid so as to significantly reduce the number of the carboxyl groups near the interface between the liquid crystal layer 30 and the alignment film 40c and near the interface between the alignment film 40c and the sealing material 50. This can suppress the occurrence of a bright dot.

In the present embodiment, the polyamic acid contained in the alignment agent C can be the same as that contained in the alignment agent A of Embodiment 1. Preferred polyamic acids for use in the alignment agent C are the same as those mentioned in Embodiment 1.

The alignment agent C may contain two or more polyamic acids, and may contain a polyamic acid having a photoreactive functional group or a polyamic acid not having a photoreactive functional group. The photoreactive functional group is slightly conductive, so that when an alignment film is formed using a polyamic acid having a photoreactive functional group, the resistance of the alignment film is reduced, resulting in a lower VHR and a higher rDC. Thus, when the alignment agent C contains a polyamic acid having a photoreactive functional group and a polyamic acid not having a photoreactive functional group, it makes it possible to form a film having a bilayer structure in which the polyamic acid having a photoreactive functional group is distributed only on the surface layer facing the liquid crystal layer 30, thus suppressing a reduction in VHR and an increase in rDC.

Preferably, the alignment agent C also contains a polysiloxane, i.e., it is also preferred to use the alignment agent A as the alignment agent C. This embodiment allows the polysiloxane to be distributed on each polymer layer 43 formed using the alignment agent C, on the side facing the liquid crystal layer 30, significantly reducing the number of the carboxyl groups present near the interface between the liquid crystal layer 30 and the alignment film 40c and near the interface between the alignment film 40c and the sealing material 50. This can further suppress the occurrence of a bright dot.

In the present embodiment, the polysiloxane contained in the alignment agent C can be the same as that contained in the alignment agent A of Embodiment 1. Preferred polysiloxanes for use in the alignment agent C are the same as those mentioned in Embodiment 1.

In the present embodiment, the alignment film 40c may impart any pre-tilt angle to the liquid crystal compound, and the alignment film 40c may be a horizontal alignment film that substantially horizontally aligns the liquid crystal compound in the liquid crystal layer 30, or a vertical alignment film that substantially vertically aligns the liquid crystal compound in the liquid crystal layer 30.

The thickness of the alignment film 40c is not particularly limited and can be appropriately set, but it is preferably 50 nm or more and 200 nm or less, more preferably 60 nm or more and 150 nm or less. When the alignment film 40c is thinner than 50 nm, it may not be possible to form a uniform alignment film on the entire substrate. When the alignment film 40c is thicker than 200 nm, the alignment film tends to have 1.5 irregularities on its surface, and the molecules of the liquid crystal compound may have various tilt angles, causing display unevenness.

The coupling layer 42 in the present embodiment and its preferred embodiments are the same as the coupling layer 42 in Embodiment 2 and its preferred embodiments.

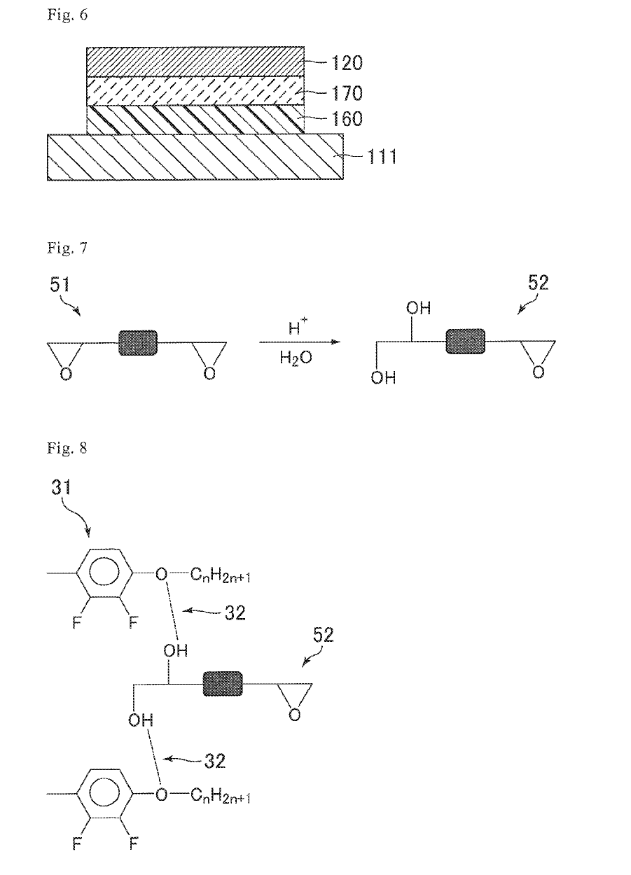

Here, differences are described between the configuration of the substrate of the liquid crystal display devices in Embodiments 2 and 3 and the configuration of an intended substrate of a liquid crystal display device of Patent Literature 1. FIG. 5 is a schematic cross-sectional view of a substrate in the liquid crystal display device of each of Embodiments 2 and 3. FIG. 6 is a schematic cross-sectional view of the intended substrate in the liquid crystal display device of Patent Literature 1.

As shown in FIG. 5, in the substrate in the liquid crystal display device of each of Embodiments 2 and 3, a resist film 70 is disposed on a transparent substrate 11, and the resist film 70, an electrode 60, and an alignment film 40 are disposed in the stated order from the transparent substrate 11. In contrast, as shown in FIG. 6, in the intended substrate in the liquid crystal display device of Patent Literature 1, a resist film 170 is disposed on an electrode 160 disposed on a transparent substrate 111, and a unimolecular film 120 is formed on the surface of the resist film 170. As described above, the configuration of the substrate in the liquid crystal display device of each of Embodiments 2 and 3 is considered to be different from the configuration of the intended substrate in the liquid crystal display device of Patent Literature 1.

### Embodiment 4

The method of producing a liquid crystal display device of Embodiment 4 is a method of producing the liquid crystal display device of Embodiment 1. In the present embodiment, features specific to the present embodiment are mainly described, and descriptions of the same features as in Embodiment 1 are suitably omitted.

The method of producing a liquid crystal display device of the present embodiment includes: an alignment film forming step of forming an alignment film on each of the first substrate 10 and the second substrate 20; a sealant applying step of applying an epoxy resin-containing sealant to the at least one of the first substrate 10 or the second substrate 20; a sealant curing step of bonding the first substrate 10 and the second substrate 20 together and curing the sealant; and a liquid crystal layer forming step of forming the liquid crystal layer 30 between the first substrate 10 and the second substrate 20 using a liquid crystal material that contains an alkoxy group-containing liquid crystal compound and that exhibits a liquid crystal phase at −10° C. or higher and 80° C. or lower, wherein the methods includes, as the alignment film forming step, a first step of forming the polymer layer 41 on each of the first substrate 10 and the second substrate 20 using the alignment agent A containing a polyamic acid and a polysiloxane. Each step is described in detail below.

### <Alignment Film Forming Step (First Step)>

The method of producing a liquid crystal display device of the present embodiment includes an alignment film forming step of forming an alignment film on each of the first substrate 10 and the second substrate 20, wherein the methods includes, as the alignment film forming step, a first step of forming the polymer layer 41 on each of the first substrate 10 and the second substrate 20 using the alignment agent A containing a polyamic acid and a polysiloxane. In the alignment film forming step, the alignment agent A containing a polyamic acid and a polysiloxane is applied to each of the first substrate 10 and the second substrate 20, and then the alignment agent A is subjected to pre-baking and post-baking by heating and is further subjected to the alignment treatment. Thus, the alignment films 40a are formed.

The pre-baking is preferably performed at 60° C. to 120° C. for 1 minute to 30 minutes, more preferably at 70° C. to 110° C. for 2 minutes to 10 minutes.

The post-baking is preferably performed at 150° C. to 300° C. for 5 minutes to 200 minutes, more preferably at 200° C. to 260° C. for 20 minutes to 60 minutes.

The alignment treatment method is not particularly limited. Examples include rubbing alignment treatment and photoalignment treatment. The photoalignment treatment is particularly preferred. With the photoalignment treatment, the surface of each alignment film 40a can be alignment-treated in a non-contact manner. Thus, dust or the like from the alignment treatment can be avoided.

The rubbing alignment treatment is a method in which a roller wrapped with cloth such as nylon is rotated and pushed at a given pressure against the first substrate 10 and the second substrate 20 to which the alignment film 40a is applied, whereby the surface of each alignment film 40a is rubbed in a given direction.

The photoalignment treatment is a method in which the photoalignment film formed of a photoalignable material is irradiated with linearly polarized ultraviolet light to selectively change the structure of the photoalignment film in the polarization direction, whereby the photoalignment film is provided with anisotropy and the liquid crystal compound is aligned at a given azimuth angle. The “photoalignable material” refers to materials in general that undergo structural changes when irradiated with light such as ultraviolet light or visible light (electromagnetic wave) and exhibit properties (alignment controlling force) to control the alignment of a nearby liquid crystal compound, and cause changes in the level and/or direction of the alignment controlling force of the alignment film. Examples of the photoalignable material include those having a photoreactive site that undergoes a reaction such as dimerization (dimer formation), isomerization, photo Fries rearrangement, or degradation when irradiated with light.

Examples of the photoreactive site (functional group) that undergoes dimerization and isomerization by light irradiation include cinnamate, chalcone, coumarin, and stilbene. Examples of the photoreactive site (functional group) that undergoes isomerization by light irradiation include azobenzene. Examples of the photoreactive site that undergoes photo Fries rearrangement by light irradiation include a phenolic ester structure. Examples of the photoreactive site that undergoes degradation by light irradiation include a cyclobutane structure.

The alignment agent A can be applied to each of the first substrate 10 and the second substrate 20 by a method such as spin coating, roll coating, printing, dip coating, die coating, casting, bar coating, blade coating, spray coating, gravure coating, reverse coating, or extrusion coating.

In addition to the polyamic acid and the polysiloxane, the alignment agent A preferably contains a solvent such as N-methyl-2-pyrrolidone (NMP) or γ-butyrolactone. One solvent may be used alone, or two or more solvents may be used in combination.

### <Sealant Applying Step>

The sealant applying step in the present embodiment is a step of applying an epoxy resin-containing sealant to at least one of the first substrate 10 or the second substrate 20. In the sealant applying step, for example, the sealant is applied to the periphery of a region in the first substrate 10 which is intended to be a display region of the liquid crystal display device in such a manner that the sealant surrounds the display region. The sealant can be applied with a dispenser, for example, which can eject a certain amount of the sealant.

### <Sealant Curing Step>

The sealant curing step of the present embodiment is a step of bonding the first substrate 10 and the second substrate 20 together and curing the sealant to form the sealing material 50. The sealant may be a photo-curable sealant that is cured by ultraviolet light or the like or may be a thermosetting sealant that is cured by heating. The sealant curing step involves curing of the sealant by ultraviolet light or heat. When a photo-curable sealant is used, for example, the first substrate 10 and the second substrate 20 are bonded together by irradiating the sealant with ultraviolet light, with the display region shielded from light.

### <Liquid Crystal Layer Forming Step>

The liquid crystal layer forming step of the present embodiment is a step of forming the liquid crystal layer 30 between the first substrate 10 and the second substrate 20 using a liquid crystal material that contains an alkoxy group-containing liquid crystal compound and that exhibits a liquid crystal phase at −10° C. or higher and 80° C. or lower. In the liquid crystal layer forming step, for example, the liquid crystal layer 30 is formed by injecting a liquid crystal material between the first substrate 10 and the second substrate 20 by vacuum injection or one drop filling. In the case of the vacuum injection, application of a sealant, bonding of the first substrate 10 and the second substrate 20, curing of the sealant, injection of a liquid crystal material, and sealing of an injection port are performed in the stated order, whereby the liquid crystal material is enclosed by the sealing material 50, and the liquid crystal layer 30 is thus formed. In the case of the one drop filling, application of a sealant, dropping of a liquid crystal material, bonding of the first substrate 10 and the second substrate 20, and curing of the sealant are performed in the stated order, whereby the liquid crystal material is enclosed, and the liquid crystal layer 30 is thus formed.

### Embodiment 5

Embodiment 5 is a method of producing the liquid crystal display device of Embodiment 2. In the present embodiment, features specific to the present embodiment are mainly described, and descriptions of the same features as in Embodiment 2 are suitably omitted.

The method of producing a liquid crystal display device of the present embodiment includes an alignment film forming step of forming an alignment film on each of the first substrate 10 and the second substrate 20; a sealant applying step of applying an epoxy resin-containing sealant to the at least one of the first substrate 10 or the second substrate 20; a sealant curing step of bonding the first substrate 10 and the second substrate 20 together and curing the sealant; and a liquid crystal layer forming step of forming the liquid crystal layer 30 between the first substrate 10 and the second substrate 20 using a liquid crystal material that contains an alkoxy group-containing liquid crystal compound and that exhibits a liquid crystal phase at −10° C. or higher and 80° C. or lower, wherein the method includes, as the alignment film forming step, a step of chemically adsorbing a silane coupling agent onto the surface of the polymer layer 41 formed using the alignment agent B, after the first step of forming the polymer layer 41 on each of the first substrate 10 and the second substrate 20 using the alignment agent B containing a polyamic acid and a polysiloxane. The step of chemically adsorbing the silane coupling agent is also referred to as a coupling layer forming step. The coupling layer forming step is described in detail below. The first step in the present embodiment and its preferred embodiments are the same as the first step in Embodiment 4 and its preferred embodiments.

### <Coupling Layer Forming Step>

In the coupling layer forming step in the present embodiment, a coupling composition containing a silane coupling agent is applied to each polymer layer 41 formed using the alignment agent B, and heated, and subsequently, an unreacted portion of the silane coupling agent is removed by washing. Thus, the coupling layers 42 are formed. The silane coupling agent is preferably heated at 70° C. to 140° C. for 1 minute to 60 minutes, more preferably at 110° C. to 130° C. for 5 to 40 minutes.

The coupling composition may contain a component other than the silane coupling agent. Examples of the component other than the silane coupling agent include a solvent such as ethanol. A highly polar solvent is preferably used. The coupling composition may contain one or more solvents.

Preferably, a solvent is used in washing to remove an unreacted portion of the silane coupling agent. Use of a highly polar solvent is more preferred. Use of a solvent that contains at least one of water or ethanol is still more preferred.

### Embodiment 6

Embodiment 6 is a method of producing the liquid crystal display device of Embodiment 3. In the present embodiment, features specific to the present embodiment are mainly described, and descriptions of the same features as in Embodiment 3 are suitably omitted.

The method of producing a liquid crystal display device of the present embodiment includes an alignment film forming step of forming an alignment film on each of the first substrate 10 and the second substrate 20; a sealant applying step of applying an epoxy resin-containing sealant to the at least one of the first substrate 10 or the second substrate 20; a sealant curing step of bonding the first substrate 10 and the second substrate 20 together and curing the sealant; and a liquid crystal layer forming step of forming the liquid crystal layer 30 between the first substrate 10 and the second substrate 20 using a liquid crystal material that contains an alkoxy group-containing liquid crystal compound and that exhibits a liquid crystal phase at −10° C. or higher and 80° C. or lower, wherein the method includes, as the alignment film forming step, a second step of chemically adsorbing a silane coupling agent onto the surface of the polymer layer 43 using the alignment agent C containing a polyamic acid, after forming the polymer layer 43 on each of the first substrate 10 and the second substrate 20 using the alignment agent C containing a polyamic acid.

### <Alignment Film Forming Step (Second Step)>

The method of producing a liquid crystal display device of the present embodiment includes, as the alignment film forming step, the second step of chemically adsorbing a silane coupling agent onto the surface of the polymer layer 43 formed using the alignment agent C, after forming the polymer layer 43 on each of the first substrate 10 and the second substrate 20 using the alignment agent C containing a polyamic acid. In the second step, a coupling composition containing the silane coupling agent is applied to each polymer layer 43 formed using the alignment agent C, and heated, and subsequently, an unreacted portion of the silane coupling agent is removed by washing. Thus, the coupling layers 42 are formed. The silane coupling agent is preferably heated at 70° C. to 140° C. for 1 to 60 minutes, more preferably at 110° C. to 130° C. for 5 to 40 minutes.

The alignment agent C may contain two or more polyamic acids, and may contain a polyamic acid having a photoreactive functional group and a polyamic acid not having a photoreactive functional group. This embodiment can suppress a decrease in VHR and an increase in rDC.

Preferably, the alignment agent C also contains a polysiloxane, i.e., it is also preferred to use the alignment agent A as the alignment agent C. This embodiment can significantly reduce the number of the carboxyl groups near the interface between the liquid crystal layer 30 and the alignment film 40c and near the interface between the alignment film 40c and the sealing material 50. This can further suppress the occurrence of a bright dot.

### Other Embodiment

In the description of the above embodiments, the first substrate 10 and the second substrate 20 include the same type of alignment films. However, the first substrate 10 and the second substrate 20 may include different types of alignment films. For example, it may be a liquid crystal display device including the alignment film 40a on one of the first substrate 10 or the second substrate 20, and the alignment film 40b on the other substrate; a liquid crystal display device including the alignment film 40a on one of the first substrate 10 or the second substrate 20, and the alignment film 40c on the other substrate; or a liquid crystal display device including the alignment film 40b on one of the first substrate 10 or the second substrate 20, and the alignment film 40c on the other substrate.

Hereinafter, the present invention is described in more detail based on examples. The examples, however, are not intended to limit the scope of the present invention.

### Examples 1-1 and 1-2 and Comparative Example 1

### Production of Liquid Crystal Display Device of Example 1-1

A VATN mode (UV²A (ultra-violet induced multi-domain vertical alignment) mode) liquid crystal display device of Example 1-1 in which photoalignment treatment is performed by ultraviolet light irradiation was produced by the following method.

First, paired substrates each including ITO electrodes were provided. Next, an alignment agent that contains a polysiloxane containing a cinnamate group represented by the following chemical formula (PS2-1) and a polyamic acid not containing a cinnamate group (imidization ratio=0%) represented by the following chemical formula (PA2-1) and that corresponds to the first alignment agent (polysiloxane containing a cinnamate group:polyamic acid not containing a cinnamate group=1:9 (weight ratio)) was applied to each substrate, followed by pre-baking at 90° C. for 5 minutes and then post-baking at 230° C. for 40 minutes. Thus, polymer layers were formed. Each polymer layer had a bilayer structure (the upper layer facing the liquid crystal layer: a layer mainly containing a polysiloxane containing a cinnamate group; the lower layer facing the substrate: a layer mainly containing a polyamic acid not containing a cinnamate group).

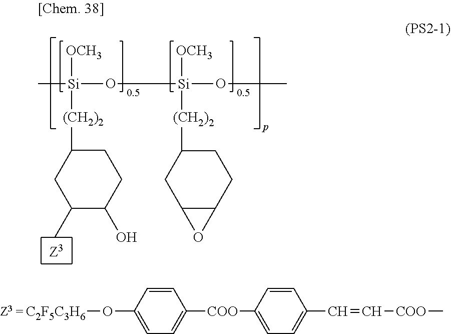

In the chemical formula (PS2-1), p represents an integer of 1 or greater.

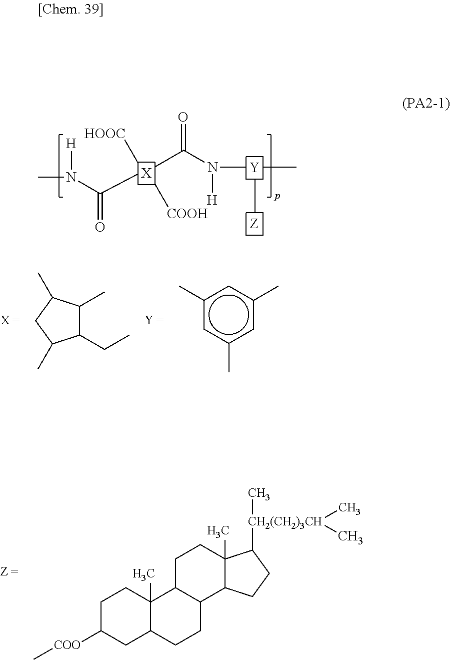

In the chemical formula (PA2-1), p represents an integer of 1 or greater.

Subsequently, the surface of the polymer layer on each substrate was irradiated with linearly polarized ultraviolet light having a center wavelength of 330 nm with a dose of 20 mJ/cm² for alignment treatment. Thus, alignment films each corresponding to the first alignment film were obtained.

Next, an ultraviolet-curable sealant (containing an epoxy group-containing compound) was applied to one of the substrates using a dispenser. A negative liquid crystal material (liquid crystal phase temperature: −30° C. to 90° C.) containing 10% by weight of a liquid crystal compound represented by the following chemical formula (L3-1) relative to the whole material was dropped onto a predetermined position of the other substrate.

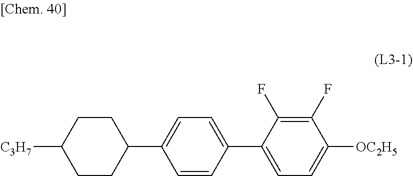

Subsequently, the substrates were bonded together under vacuum, and the sealant was cured into a sealing material by ultraviolet light. Further, the obtained liquid crystal cell was heated at 130° C. for 40 minutes to transform the liquid crystal into the isotropic phase for realignment treatment, and a liquid crystal layer was thus formed, followed by cooling to room temperature. Thus, the VATN mode (UV²A mode) liquid crystal display device of Example 1-1 was produced.

### Production of Liquid Crystal Display Device of Example 1-2

A VATN mode (UV²A mode) liquid crystal display device of Example 1-2 was produced by the same method as in Example 1-1, except that the mixing ratio of the components in the alignment agent was changed as follows: polysiloxane containing a cinnamate group:polyamic acid not containing a cinnamate group=2:8 (weight ratio).

### Production of Liquid Crystal Display Device of Comparative Example 1

A VATN mode (UV²A mode) liquid crystal display device of Comparative Example 1 was produced by the same method as in Example 1-1, except that a polyamic acid containing a cinnamate group on a side chain (imidization ratio=0%) represented by the following chemical formula (PA2-2) was used instead of the polysiloxane containing a cinnamate group represented by the chemical formula (PS2-1):

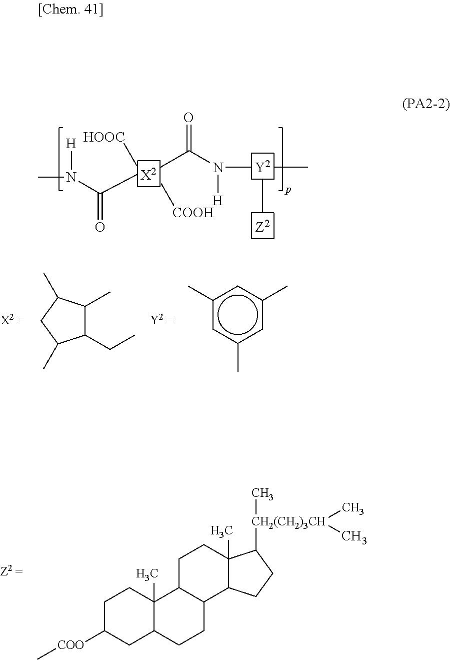

wherein p is an integer of 1 or greater.

### <High and Low Temperature Cycle Test on Backlight Unit>

The liquid crystal display devices produced in Examples 1-1 and 1-2 and Comparative Example 1 were evaluated for heat resistance by the following cycle test. Each of the liquid crystal display devices of Examples 1-1 and 1-2 and Comparative Example 1 was placed on a backlight unit, and was subjected to repeated cycles of heating at 80° C. for 5 hours and cooling at −30° C. for 5 hours to perform a high and low temperature cycle test. The test was repeatedly performed for 1000 hours.

After the high and low temperature cycle test was repeatedly performed for 1000 hours, the occurrence of a bright dot at the edge of the sealing material of the liquid crystal display device was visually checked. Further, the VHR and the rDC were measured before and after the high and low temperature cycle test. Table 1 below shows the results. The VHR was measured at 1 V and 70° C. using a VHR measurement system Model 6254 available from Toyo Corporation. The rDC was measured by a flicker-minimizing method after a DC offset voltage of 2 V (AC voltage 3 V (60 Hz)) was applied for two hours. To evaluate the occurrence of a bright dot, five liquid crystal display devices were provided from each of Examples 1-1 and 1-2 and Comparative Example 1, and evaluation was made by counting the number of liquid crystal display devices in which a bright dot had occurred.

TABLE 1

| | | 0 hours | | | After 1000 hours | | |
|---|---|---|---|---|---|---|---|
| | | VHR | rDC | | VHR | rDC | |
| | Alignment film | (%) | (mV) | Appearance | (%) | (mV) | Appearance |
| Example 1-1 | (PS2-1):(PA2-1) = 1:9 | 99.1 | −20 | No bright dot | 96.1 | 60 | No bright dot |
| Example 1-2 | (PS2-1):(PA2-1) = 2:8 | 99.0 | −20 | No bright dot | 97.0 | 20 | No bright dot |
| Comparative | (PA2-2):(PA2-1) = 1:9 | 99.5 | 90 | No bright dot | 92.9 | 410 | Bright dots |
| Example 1 | | | | | | | occurred (in |
| | | | | | | | two out of |
| | | | | | | | five display |
| | | | | | | | devices). |

In the liquid crystal display devices of Examples 1-1 and 1-2 in which the alignment agent containing a polysiloxane was used, the VHR was high and the rDC was low after the 1000-hour cycle test, as compared to the liquid crystal display devices of Comparative Example 1 in which a polysiloxane was not used. In addition, in Comparative Example 1, no bright dot was observed at the edge of the sealing material in two out of five liquid crystal display devices, but a bright dot did not occur in any of the liquid crystal devices in either of Example 1-1 or 1-2.

The reason is presumed as follows. In the liquid crystal display devices in Examples 1-1 and 1-2, presumably, since each alignment film had a bilayer structure and the polysiloxane was distributed near the interface of the alignment film, on the side facing the liquid crystal layer, it was possible to significantly reduce the number of the carboxyl groups near the interface between the liquid crystal layer and the alignment film and near the interface between the alignment film and the sealing material, suppressing the occurrence of a bright dot. In contrast, in the liquid crystal display device of Comparative Example 1, presumably, the number of residual carboxyl groups was large near the interface between the alignment films and the liquid crystal layer and the like, an uncured epoxy resin in the sealing material was easily converted into a diol, and the diol dissolved into the liquid crystal layer, facilitating precipitation due to aggregation between the diol and the alkoxy group-containing liquid crystal compound.

The liquid crystal display devices of Examples 1-1 and 1-2 showed no large precipitate at the edge of the sealing material, and no bright dot was observed. Yet, according to a comparison between Examples 1-1 and 1-2, the liquid crystal display device of Example 1-2 with a higher proportion of the polysiloxane containing a cinnamate group exhibited a higher VHR and a lower rDC after the 1000-hour cycle test. This suggests that when the proportion of the polyamic acid is higher, the carboxyl group content is higher, possibly facilitating conversion of an uncured epoxy group into a diol and dissolution of the diol into the liquid crystal layer.

### Examples 2-1 and 2-2

### Production of Liquid Crystal Display Devices of Examples 2-1 and 2-2

VATN mode (UV²A mode) liquid crystal display devices of Examples 2-1 and 2-2 were produced by the same methods as in Examples 1-1 and 1-2, respectively, except that the following step was additional performed.

In Examples 2-1 and 2-2, the following step was performed after the alignment treatment in Examples 1-1 and 1-2, respectively. Specifically, a silane coupling composition containing a silane coupling agent represented by the following chemical formula (SC5) and ethanol was applied to each alignment-treated polymer layer, and heated at 120° C. for 20 minutes. Then, an unreacted portion of the silane coupling agent was removed by washing with water. Thus, alignment films each including a coupling layer on the polymer layer and corresponding to the first alignment film or the second alignment film were formed.

[Chem. 42]

(OEt)₃Si—(CH₂)₁₁—CF₃ (SC5)

### <High and Low Temperature Cycle Test on Backlight Unit>

By the same method as in Example 1-1 or the like, the liquid crystal display devices of Examples 2-1 and 2-2 were subjected to the high and low temperature cycle test on the backlight unit. Table 2 below shows the results.

TABLE 2

| | | 0 hours | | | After 1000 hours | | |
|---|---|---|---|---|---|---|---|
| | | VHR | rDC | | VHR | rDC | |
| | Alignment film | (%) | (mV) | Appearance | (%) | (mW) | Appearance |
| Example 2-1 | (PS2-1):(PA2-1) = 1:9 | 98.7 | 0 | No bright dot | 97.8 | 10 | No bright dot |
| | + | | | | | | |
| | silane coupling | | | | | | |
| | agent (SC5) | | | | | | |
| Example 2-2 | (PS2-1):(PA2-1) = 2:8 | 98.5 | −10 | No bright dot | 97.8 | 0 | No bright dot |
| | + | | | | | | |
| | silane coupling | | | | | | |
| | agent (SC5) | | | | | | |

The liquid crystal display devices of Examples 2-1 and 2-2 were capable of maintaining the VHR at a higher level and the rDC at a low level after the 1000-hour cycle test. Presumably, since the surface of each polymer layer formed using the alignment agent containing a polyamic acid and a polysiloxane was further treated with a silane coupling agent, the number of residual carboxyl groups on the polymer layer was reduced, further effectively suppressing conversion of an uncured epoxy resin in the sealing material into a diol.

### Example 3

### Production of Liquid Crystal Display Device of Example 3

A VATN mode (UV²A mode) liquid crystal display device of Example 3 was produced by the same method as in Example 2-2, except that the alignment agent that contains the polyamic acid containing a cinnamate group represented by the chemical formula (PA2-2) and a polyamic acid not containing a cinnamate group (imidization ratio=0%) represented by the following chemical formula (PA1-1) (polyamic acid containing a cinnamate group:polyamic acid not containing a cinnamate group=2:8 (weight ratio)) was used. In other words, in this example, alignment films each including a coupling layer on the surface of the polymer layer and corresponding to the second alignment film were formed.

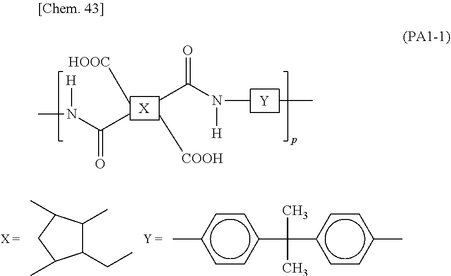

In the chemical formula (PA1-1), p is an integer of 1 or greater.

### <High and Low Temperature Cycle Test on Backlight Unit>

By the same method as in Example 1-1 or the like, the liquid crystal display device of Example 3 was subjected to the high and low temperature cycle test on the backlight unit. Table 3 below shows the results.

TABLE 3

| | | 0 hours | | | After 1000 hours | | |
|---|---|---|---|---|---|---|---|
| | | VHR | rDC | | VHR | rDC | |
| | Alignment film | (%) | (mV) | Appearance | (%) | (mV) | Appearance |
| Example 3 | (PA2-2):(PA1-1) = 2:8 | 99.2 | 50 | No bright dot | 97.0 | 120 | No bright dot |
| | + | | | | | | |
| | silane coupling agent (SC5) | | | | | | |

The liquid crystal display devices of Example 3 showed no bright dot at the edge of the sealing material even after the 1000-hour cycle test, and achieved a high VHR and a low rDC. Presumably, since the surface of each polymer layer formed using the alignment agent containing a polyamic acid was treated with the silane coupling agent to form a coupling layer, the number of residual carboxyl groups on the polymer layer was reduced, which further effectively suppressed conversion of an uncured epoxy resin in the sealing material into a diol.

### Example 4 and Comparative Example 2

### Production of Liquid Crystal Display Device of Example 4

An FFS mode liquid crystal display device of Example 4 was produced by the following method.

First, a TFT substrate and a counter substrate not including electrodes were provided. Next, an alignment agent containing a polyamic acid (imidization ratio=0%) represented by the following chemical formula (PA1-2) having a cyclobutane ring on the main chain and the polyamic acid (imidization ratio=0%) represented by the chemical formula (PA1-1) not having a cyclobutane ring (polyamic acid containing a cyclobutane ring:polyamic acid not containing a cyclobutane ring=2:8 (weight ratio)) was applied to both substrates. Pre-baking was performed at 90° C. for 5 minutes, and then post-baking was performed at 230° C. for 40 minutes. Thus, polymer layers were formed. Each polymer layer had a bilayer structure. In the bilayer structure, the upper layer facing the liquid crystal layer was a layer mainly containing a polyamic acid having a cyclobutane ring, and the lower layer facing the substrate was a layer mainly containing a polyamic acid not having a cyclobutane ring.

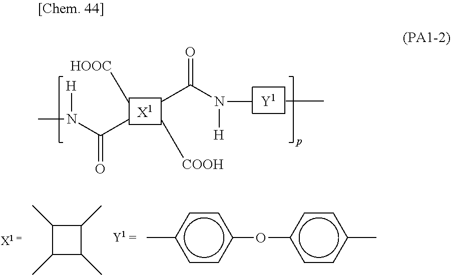

In the chemical formula (PA1-2), p represents an integer of 1 or greater.

Subsequently, the surface of the polymer layer on each substrate was irradiated with linearly polarized ultraviolet light having a center wavelength of 300 nm or less with a dose of 1 J/cm² for alignment treatment. Specifically, the cyclobutane ring which is a photoalignable functional group was degraded by irradiation with deep ultraviolet light for alignment treatment.

Next, a silane coupling composition containing a silane coupling agent represented by the following chemical formula (SC4) and ethanol was applied to each alignment-treated polymer layer, and heated at 120° C. for 20 minutes. Then, an unreacted portion of the silane coupling agent was removed by washing with water. Thus, alignment films each including a coupling layer on the polymer layer and corresponding to the second alignment film were formed.

[Chem. 45]

(OEt)₃Si—(CH₂)—CH₃ (SC4)

Next, an ultraviolet-curable sealant (containing an epoxy group-containing compound) was applied to one of the substrates using a dispenser. A negative liquid crystal material (liquid crystal phase temperature: −20° C. to 80° C.) containing 10% by weight of a liquid crystal compound represented by the following chemical formula (L4-1) relative to the whole material was dropped onto a predetermined position of the other substrate.

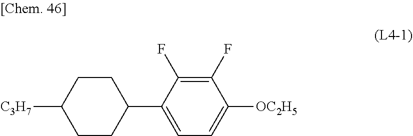

Subsequently, the substrates were bonded together under vacuum, and the sealant was cured into a sealing material by ultraviolet light. Further, the obtained liquid crystal cell was heated at 130° C. for 40 minutes to transform the liquid crystal into the isotropic phase for realigrnment treatment, and a liquid crystal layer was thus formed, followed by cooling to room temperature. Thus, the FFS mode liquid crystal display device of Example 4 was produced.

### Production of Liquid Crystal Display Device of Comparative Example 2

A liquid crystal display device of Comparative Example 2 was produced by the same method as in Example 4, except that the surface treatment with the silane coupling agent represented by the chemical formula (SC4) was not performed.

### <High and Low Temperature Cycle Test on Backlight Unit>

By the same method as in Example 1-1 or the like, the liquid crystal display devices of Example 4 and Comparative Example 2 were subjected to the high and low temperature cycle test on the backlight unit. Table 4 below shows the results.

TABLE 4

| | | 0 hours | | | After 1000 hours | | |
|---|---|---|---|---|---|---|---|
| | | VHR | rDC | | VHR | rDC | |
| | Alignment film | (%) | (mV) | Appearance | (%) | (mV) | Appearance |
| Example 4 | (PA1-2):(PA1-1) = 2:8 | 98.6 | 10 | No bright | 95.5 | 50 | No bright |
| | + | | | dot | | | dot |
| | silane coupling | | | | | | |
| | agent (SC4) | | | | | | |
| Comparative | (PA1-2):(PA1-1) = 2:8 | 99.0 | 0 | No bright | 94.1 | 160 | Bright dots |
| Example 2 | | | | dots | | | occurred (in |
| | | | | | | | three out of |
| | | | | | | | five display |
| | | | | | | | devices). |

As shown in Table 4, the liquid crystal display devices of Example 4 showed no bright dot at the edge of the sealing material even after the 1000-hour cycle test, and achieved a high VHR and a low rDC. Presumably, the number of residual carboxyl groups on each alignment film was reduced by treating the surface of the polymer layer with the silane coupling agent, further effectively suppressing conversion of an uncured epoxy resin in the sealing material into a diol. The FFS mode liquid crystal display device also exhibited the same effect as that of the VATN mode (UV²A mode) cell.

### Example 5 and Comparative Example 3

### Production of Liquid Crystal Display Device of Example 5

An FFS mode liquid crystal display device of Example 5 was produced by the following method.

First, a TFT substrate and a counter substrate not including electrodes were provided. Next, an alignment agent that contains a polysiloxane containing a cinnamate group represented by the following chemical formula (PS1-1) and the polyamic acid not containing a cinnamate group (imidization ratio=0%) represented by the chemical formula (PA1-1) (polysiloxane containing a cinnamate group:polyamic acid not containing a cinnamate group=2:8 (weight ratio)) was applied to both substrates. Pre-baking was performed at 90° C. for 5 minutes, and then post-baking was performed at 230° C. for 40 minutes. Thus, polymer layers were formed. Each polymer layer formed using the alignment agent had a bilayer structure (the upper layer of the liquid crystal layer: a layer mainly containing a polysiloxane containing a cinnamate group; the lower layer of the substrate: a layer mainly containing a polyamic acid not containing a cinnamate group).

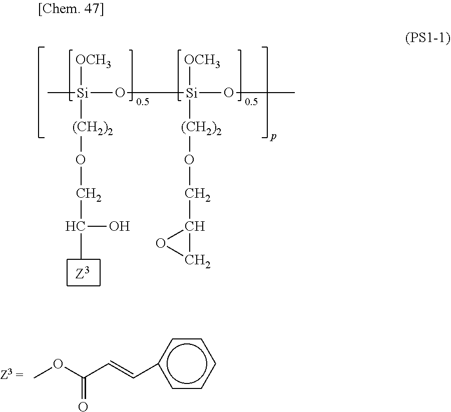

In the chemical formula (PS1-1), p represents an integer of 1 or greater.

Subsequently, the surface of the polymer layer on each substrate was irradiated with linearly polarized ultraviolet light having a center wavelength of 330 nm with a dose of 20 mJ/cm² for alignment treatment. Thus, alignment films were obtained.

Next, an ultraviolet-curable sealant (containing an epoxy group-containing compound) was applied to one of the substrates using a dispenser. A negative liquid crystal material (liquid crystal phase temperature: −30° C. to 90° C.) containing 10% by weight of a liquid crystal compound represented by the chemical formula (L3-1) relative to the whole material was dropped onto a predetermined position of the other substrate.

Subsequently, the substrates were bonded together under vacuum, and the sealant was cured into a sealing material by ultraviolet light. Further, the obtained liquid crystal cell was heated at 130° C. for 40 minutes to transform the liquid crystal into the isotropic phase for the realignment treatment, and a liquid crystal layer was thus formed, followed by cooling to room temperature. Thus, the FFS mode liquid crystal display device of Example 5 was produced. In other words, in this example, alignment films each corresponding to the first alignment film were formed.

### Production of Liquid Crystal Display Device of Comparative Example 3

An FFS mode liquid crystal display device of Comparative Example 3 was produced by the same method as in Example 5, except that a polyamic acid containing a cinnamate group on a side chain (imidization ratio=0%) represented by the following chemical formula (PA2-3) was used instead of the polysiloxane containing a cinnamate group represented by the chemical formula (PS1-1)):

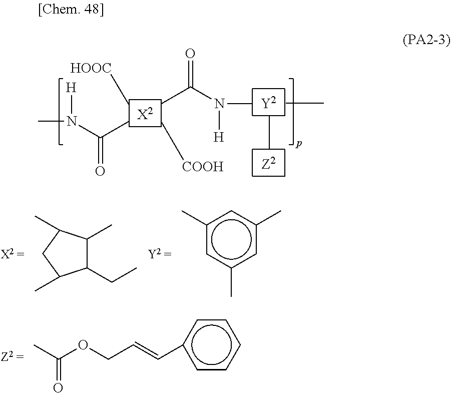

wherein p represents an integer of 1 or greater.

### <High and Low Temperature Cycle Test on Backlight Unit>

By the same method as in Example 1-1 or the like, the liquid crystal display devices of Example 5 and Comparative Example 3 were subjected to the high and low temperature cycle test on the backlight unit. Table 5 below shows the results.

TABLE 5

| | | 0 hours | | | 1000 hours | | |
|---|---|---|---|---|---|---|---|
| | | VHR | rDC | | VHR | rDC | |
| | Alignment film | (%) | (mV) | Appearance | (%) | (mV) | Appearance |
| Example 5 | (PS1-1):(PA1-1) = 2:3 | 99.1 | −20 | No bright dot | 95.8 | 30 | No bright dot |
| Comparative | (PA2-3):(PA1-1) = 2:8 | 99.4 | 10 | No bright dot | 93.3 | 190 | Bright dots |
| Example 3 | | | | | | | occurred |
| | | | | | | | (in all five |
| | | | | | | | display devices). |

As shown in Table 5, the liquid crystal display devices of Example 5 showed no a bright dot at the edge of the sealing material even after the 1000-hour cycle test, and achieved a high VHR and a low rDC. In contrast, in Comparative Example 3, all the five liquid crystal display devices showed 2 to 5 bright dots. In addition, the VHR decreased and the rDC increased. Presumably, in the liquid crystal display device of Example 5, since the polysiloxane not containing a carboxyl group was located at the interface between the alignment films and the liquid crystal layer and the like, the number of residual carboxyl groups on each alignment film was reduced as compared to Comparative Example 3, effectively suppressing conversion of an epoxy resin into a diol.

### Example 6

### Production of Liquid Crystal Display Device of Example 6

An FFS mode liquid crystal display device of Example 6 was produced by the same method as in Example 5, except that the following step was additionally performed.

In Example 6, the following step was performed after the alignment treatment in Example 5. Specifically, a silane coupling composition containing the silane coupling agent represented by the chemical formula (SC4) and ethanol was applied to each polymer layer formed using the alignment agent, and heated at 120° C. for 20 minutes. Then, an unreacted portion of the silane coupling agent was removed by washing with water. Thus, alignment films each including a coupling layer on the polymer layer and corresponding to the first alignment film or the second alignment film were formed.

### <High and Low Temperature Cycle Test on Backlight Unit>

By the same method as in Example 1-1 or the like, the liquid crystal display device of Example 6 was subjected to the high and low temperature cycle test on the backlight unit. Table 6 below shows the results.

TABLE 6

| | | 0 hours | | | After 1000 hours | | |
|---|---|---|---|---|---|---|---|
| | | VHR | rDC | | VHR | rDC | |
| | Alignment film | (%) | (mV) | Appearance | (%) | (mV) | Appearance |
| Example 6 | (PS1-1):(PA1-1) = 2:8 | 98.3 | 0 | No bright | 96.5 | 10 | No bright dot |
| | + | | | dot | | | |
| | silane coupling | | | | | | |
| | agent (SC4) | | | | | | |

The liquid crystal display devices of Example 6 showed no bright dot at the edge of the sealing material even after the 1000-hour cycle test, and achieved a high VHR and a low rDC. Presumably, the number of residual carboxyl groups on each alignment film was reduced by treating the surface of the alignment film with the silane coupling agent, further effectively suppressing conversion of an uncured epoxy resin in the sealing material into a diol.

### ADDITIONAL REMARKS

The first aspect of the present invention may be a liquid crystal display device including: the first substrate 10; the second substrate 20 disposed opposite to the first substrate 10; the liquid crystal layer 30 disposed between the first substrate 10 and the second substrate 20; the alignment film 40 on at least one of the first substrate 10 or the second substrate 20, on the side facing the liquid crystal layer 30; and the sealing material 50 to achieve adhesion between the first substrate 10 and the second substrate 20, wherein the liquid crystal layer 30 contains a liquid crystal material, the liquid crystal material contains an alkoxy group-containing liquid crystal compound and exhibits a liquid crystal phase at −10° C. or higher and 80° C. or lower, the sealing material 50 is a cured product of an epoxy resin-containing sealant, and the alignment film 40 includes at least one of the first alignment film 40a or 40b including the polymer layer 41 formed using the first alignment agent containing a pclyamic acid and a polysiloxane, or the second alignment film 40c including the polymer layer 43 formed using the second alignment agent containing a polyamic acid in which a silane coupling agent is chemically adsorbed onto a surface of the polymer layer 43.

This embodiment can significantly reduce the number of the carboxyl groups near the interface between the liquid crystal layer 30 and the alignment film 40 and near the interface between the alignment film 40 and the sealing material 50, suppressing the occurrence of a bright dot.

The liquid crystal compound may be a compound represented by the following chemical formula (L). This embodiment can provide a liquid crystal display device having good display characteristics even in an environment with large temperature changes.

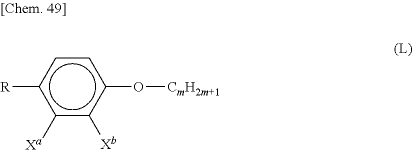

In the chemical formula (L), X^{a} and X^{b} each independently represent a hydrogen atom, a fluorine atom, or a chlorine atom; R represents a monovalent organic group; and m represents an integer of 1 to 18, with the proviso that when one of X^{a} or X^{b} is a hydrogen atom, the other one represents a fluorine atom or a chlorine atom.

The liquid crystal compound may be a compound represented by any of the following chemical formulae (L1) to (L5). This embodiment can provide a liquid crystal display device having good display characteristics even in an environment with large temperature changes.

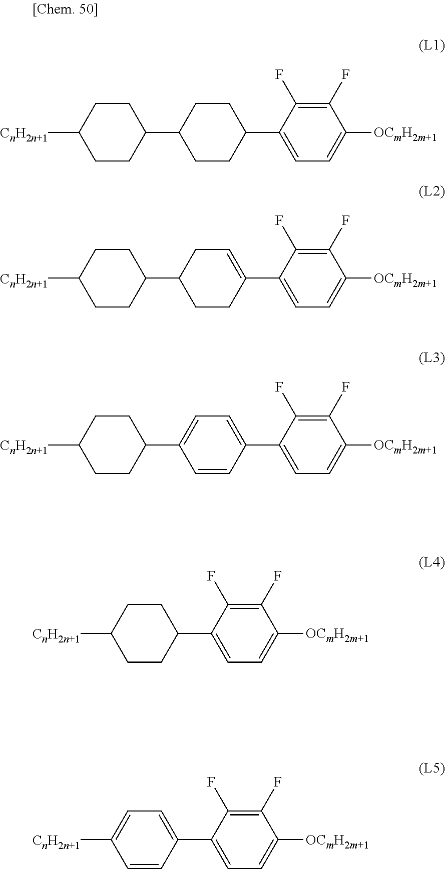

In the chemical formulae (L1) to (L5), m and n each independently represent an integer of 1 to 18.

The liquid crystal material may exhibit a liquid crystal phase at −30° C. or higher and 90° C. or lower. This embodiment can provide a liquid crystal display device that can be suitably used for in-vehicle applications and digital signage applications which require the liquid crystal material to exhibit a liquid crystal phase in a wide temperature range.

The silane coupling agent may be a compound represented by the following chemical formula (SC1). Use of the silane coupling agent may change the alignment azimuth and/or tilt angle of the liquid crystal compound, but such change can be avoided or minimized with the silane coupling agent as described above.

[Chem. 51]

(Z)₃Si—(CR¹₂)ₐ—CR²₃ (SC1)

In the chemical formula (SC1), each Z independently represents a chlorine atom, a methoxy group, or an ethoxy group; each R¹ independently represents a hydrogen atom or a halogen atom; each R² independently represents a hydrogen atom or a halogen atom; and a represents an integer of 0 to 17.

The silane coupling agent may be a compound represented by the following chemical formula (SC2) or (SC3). Use of the silane coupling agent may change the alignment azimuth and/or tilt angle of the liquid crystal compound, but such change can be avoided or minimized with the silane coupling agent as described above.

[Chem. 52]

(Z)₃Si—(CH₂)ₐ—CF₃ (SC2)

In the chemical formula (SC2), each Z independently represents a chlorine atom, a methoxy group, or an ethoxy group; and a represents an integer of 0 to 17.

[Chem. 53]

(Z)₃Si—(CH₂)_{b}—C₂F₅ (SC3)

In the chemical formula (SC3), each Z independently represents a chlorine atom, a methoxy group, or an ethoxy group; and b represents an integer of 0 to 16.

The polysiloxane may contain at least one functional group selected from the group consisting of an epoxy group and an isocyanate group. This embodiment can suppress dissolution of the polysiloxane into the liquid crystal layer 30, further suppressing the occurrence of a bright dot.

The first alignment films 40a and 40b and the second alignment film 40c each may include multiple polymer layers each containing a different polymer. This embodiment can further suppress the occurrence of a bright dot.

The alignment film 40 may include the first alignment film 40a or 40b. This embodiment allows the polysiloxane to be located adjacent to the alignment film 40, on the side facing the liquid crystal layer 30, suppressing the occurrence of a bright dot.

The first alignment film 40b may contain a silane coupling agent chemically adsorbed onto the surface of the polymer layer 41 formed using the first alignment agent. This embodiment can further suppress the occurrence of a bright dot.

The alignment film 40 may include the second alignment film 40c. The coupling layer 42 can be disposed adjacent to the alignment film 40, on the side facing the liquid crystal layer 30, suppressing the occurrence of a bright dot.

The second alignment agent may further contain a polysiloxane. This embodiment can further suppress the occurrence of a bright dot.

Another embodiment of the present invention may be a method of producing a liquid crystal display device, including: an alignment film forming step of forming the alignment film 40 on at least one of the first substrate 10 or the second substrate 20; a sealant applying step of applying an epoxy resin-containing sealant to the at least one substrate; a sealant curing step of bonding the first substrate 10 and the second substrate 20 together and curing the sealant; and a liquid crystal layer forming step of forming the liquid crystal layer 30 between the first substrate 10 and the second substrate 20 using a liquid crystal material that contains an alkoxy group-containing liquid crystal compound and that exhibits a liquid crystal phase at −10° C. or higher and 80° C. or lower, wherein the method includes, as the alignment film forming step, at least one of a first step of forming a polymer layer on the at least one substrate using a first alignment agent containing a polyamic acid and a polysiloxane, or a second step of forming a polymer layer on the at least one substrate using a second alignment agent containing a polyamic acid and then chemically adsorbing a silane coupling agent onto the surface of the polymer layer.

This embodiment can significantly reduce the number of the carboxyl groups near the interface between the liquid crystal layer 30 and the alignment film 40 and near the interface between the alignment film 40 and the sealing material 50, suppressing the occurrence of a bright dot.

The method of producing a liquid crystal display device may include, as the alignment film forming step, the first step but not the second step.

The method of producing a liquid crystal display device may further include, as the alignment film forming step, a step of chemically adsorbing a silane coupling agent onto the surface of the polymer layer formed using the first alignment agent, after the first step. This embodiment can further suppress the occurrence of a bright dot.

The method of producing a liquid crystal display device may include, as the alignment film forming step, the second step but not the first step.

The second alignment agent may further contain a polysiloxane. This embodiment can further suppress the occurrence of a bright dot.

The liquid crystal compound may be a compound represented by the following chemical formula (L). This embodiment can provide a liquid crystal display device having good display characteristics even in an environment with large temperature changes.

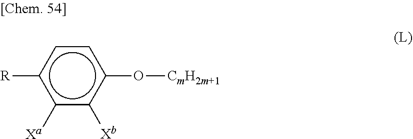

In the chemical formula (L), X^{a} and X^{b} each independently represent a hydrogen atom, a fluorine atom, or a chlorine atom; R represents a monovalent organic group; and m represents an integer of 1 to 18, with the proviso that when one of X^{a} or X^{b} is a hydrogen atom, the other one represents a fluorine atom or a chlorine atom.

The liquid crystal compound may be a compound represented by any of the following chemical formulae (L1) to (L5). This embodiment can provide a liquid crystal display device having good display characteristics even in an environment with large temperature changes.

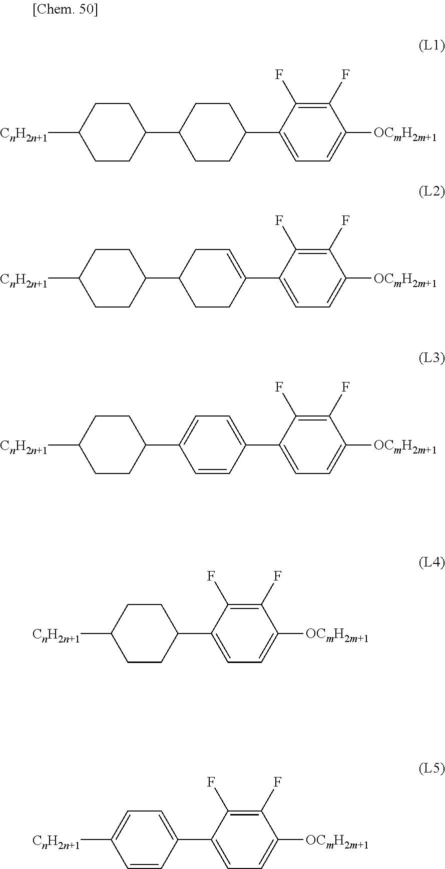

In the chemical formulae (L1) to (L5), m and n each independently represent an integer of 1 to 18.

The liquid crystal material may exhibit a liquid crystal phase at −30° C. or higher and 90° C. or lower. This embodiment can provide a liquid crystal display device that can be suitably used for in-vehicle applications and digital signage applications which require the liquid crystal material to exhibit a liquid crystal phase in a wide temperature range.

The silane coupling agent may be a compound represented by the following chemical formula (SC1). Use of the silane coupling agent may change the alignment azimuth and/or tilt angle of the liquid crystal compound, but such change can be avoided or minimized with the silane coupling agent as described above.

[Chem. 56]

(Z)₃Si—(CR¹₂)ₐ—CR²₃ (SC1)

In the chemical formula (SC1), each Z independently represents a chlorine atom, a methoxy group, or an ethoxy group; each R¹ independently represents a hydrogen atom or a halogen atom; each R¹ independently represents a hydrogen atom or a halogen atom; and a represents an integer of 0 to 17.

The silane coupling agent may be a compound represented by the following chemical formula (SC2) or (SC3). Use of the silane coupling agent may change the alignment azimuth and/or tilt angle of the liquid crystal compound, but such change can be avoided or minimized with the silane coupling agent as described above.

[Chem. 57]

(Z)₃Si—(CH₂)ₐ—CF₃ (SC2)

In the chemical formula (SC2), each Z independently represents a chlorine atom, a methoxy group, or an ethoxy group; and a represents an integer of 0 to 17.

[Chem. 58]

(Z)₃Si—(CH₂)_{b}—C₂F₅ (SC3)

In the chemical formula (SC3), each Z independently represents a chlorine atom, a methoxy group, or an ethoxy group; and b represents an integer of 0 to 16.

The polysiloxane may contain at least one functional group selected from the group consisting of an epoxy group and an isocyanate group. This embodiment can suppress dissolution of the polysiloxane into the liquid crystal layer 30, further suppressing the occurrence of a bright dot.

The alignment film 40 may include multiple polymer layers each containing a different polymer. This embodiment can further suppress the occurrence of a bright dot.

### REFERENCE SIGNS LIST

1A, 1B, 1C: liquid crystal display device
10: first substrate
11: transparent substrate
20: second substrate
30: liquid crystal layer
31: alkoxy group-containing liquid crystal compound
32: hydrogen bond
40, 40a, 40b, 40c: alignment film
41: polymer layer formed using alignment agent containing polyamic acid and polysiloxane
41a: layer formed from polyamic acid
41b: layer formed from polysiloxane
42: coupling layer
43: polymer layer formed using alignment agent containing polyamic acid
50: sealing material
51: epoxy resin contained in sealing material
52: epoxy resin converted into diol
60, 160: electrode
70, 170: resist film
111: transparent substrate
120: unimolecular film
E: end of silane coupling agent

1. A liquid crystal display device comprising:
a first substrate;
a second substrate disposed opposite to the first substrate;
a liquid crystal layer disposed between the first substrate and the second substrate;
an alignment film disposed on at least one of the first substrate or the second substrate, on the side facing the liquid crystal layer; and
a sealing material to achieve adhesion between the first substrate and the second substrate,
wherein the liquid crystal layer contains a liquid crystal material,
the liquid crystal material contains an alkoxy group-containing liquid crystal compound and exhibits a liquid crystal phase at −10° C. or higher and 80° C. or lower,
the sealing material is a cured product of an epoxy resin-containing sealant, and
the alignment film comprises at least one of a first alignment film including a polymer layer formed using a first alignment agent containing a polyamic acid and a polysiloxane, or a second alignment film including a polymer layer formed using a second alignment agent containing a polyamic acid in which a silane coupling agent is chemically adsorbed onto a surface of the polymer layer.

2. The liquid crystal display device according to claim 1,
wherein the liquid crystal compound is a compound represented by the following chemical formula (L): 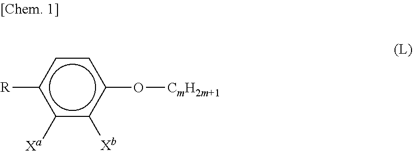
wherein X^{a} and X^{b} each independently represent a hydrogen atom, a fluorine atom, or a chlorine atom; R represents a monovalent organic group; and m represents an integer of 1 to 18, with the proviso that when one of X^{a} or X^{b} is a hydrogen atom, the other one represents a fluorine atom or a chlorine atom.

3. The liquid crystal display device according to claim 1,
wherein the liquid crystal compound is a compound represented any one of the following chemical formulae (L1) to (L5): 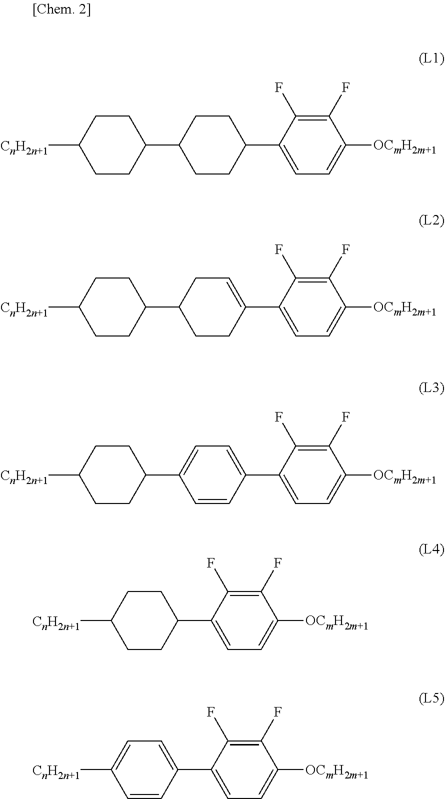
wherein m and n each independently represent an integer of 1 to 18.

4. The liquid crystal display device according to claim 1,
wherein the liquid crystal material exhibits a liquid crystal phase at −30° C. or higher and 90° C. or lower.

5. The liquid crystal display device according to claim 1,
wherein the silane coupling agent is a compound represented by the following chemical formula (SC1):
[Chem. 3]
(Z)₃Si—(CR¹₂)ₐ—CR²₃ (SC1)
wherein each Z independently represents a chlorine atom, a methoxy group, or an ethoxy group; each R¹ independently represents a hydrogen atom or a halogen atom; each R² independently represents a hydrogen atom or a halogen atom; and a represents an integer of 0 to 17.

6. The liquid crystal display device according to claim 1,
wherein the silane coupling agent is a compound represented by the following chemical formula (SC2) or (SC3):
[Chem. 4]
(Z)₃Si—(CH₂)ₐ—CF₃ (SC2)
wherein each Z independently represents a chlorine atom, a methoxy group, or an ethoxy group; and a represents an integer of 0 to 17,
[Chem. 5]
(Z)₃Si—(CH₂)_{b}—C₂F₅ (SC3)
wherein each Z independently represents a chlorine atom, a methoxy group, or an ethoxy group; and b represents an integer of 0 to 16.

7. The liquid crystal display device according to claim 1,
wherein the polysiloxane comprises at least one functional group selected from the group consisting of an epoxy group and an isocyanate group.

8. The liquid crystal display device according to claim 1,
wherein the first alignment film and the second alignment film each comprise multiple polymer layers each containing a different polymer.

9. The liquid crystal display device according to claim 1,
wherein the alignment film comprises the first alignment film.

10. The liquid crystal display device according to claim 9,
wherein the first alignment film comprises a silane coupling agent chemically adsorbed onto the surface of the polymer layer formed using the first alignment agent.

11. The liquid crystal display device according to claim 1,
wherein the alignment film comprises the second alignment film.

12. The liquid crystal display device according to claim 11,
wherein the second alignment agent further comprises a polysiloxane.

13. A method of producing a liquid crystal display device, comprising:
an alignment film forming step of forming an alignment film on at least one of a first substrate or a second substrate;
a sealant applying step of applying an epoxy resin-containing sealant to the at least one substrate;
a sealant curing step of bonding the first substrate and the second substrate together and curing the sealant; and
a liquid crystal layer forming step of forming a liquid crystal layer between the first substrate and the second substrate using a liquid crystal material that contains an alkoxy group-containing liquid crystal compound and that exhibits a liquid crystal phase at −10° C. or higher and 80° C. or lower,
wherein the method comprises, as the alignment film forming step, at least one of a first step of forming a polymer layer on the at least one substrate using a first alignment agent containing a polyamic acid and a polysiloxane, or a second step of forming a polymer layer on the at least one substrate using a second alignment agent containing a polyamic acid and then chemically adsorbing a silane coupling agent onto a surface of the polymer layer.

14. The method of producing a liquid crystal display device according to claim 13,
wherein the methods comprises, as the alignment film forming step, the first step but not the second step.

15. The method of producing a liquid crystal display device according to claim 14, further comprising, as the alignment film forming step, a step of chemically adsorbing a silane coupling agent onto the surface of the polymer layer formed using the first alignment agent, after the first step.

16. The method of producing a liquid crystal display device according to claim 13,
wherein the method comprises, as the alignment film forming step, the second step but not the first step.

17. The method of producing a liquid crystal display device according to claim 16,
wherein the second alignment agent further comprises a polysiloxane.
